(19) United States
(12) Patent Application Publication
(10) Pub. No.: US 2026/0187805 A1
(43) Pub. Date: Jul. 2, 2026

(54) OPHTHALMOLOGIC IMAGE PROCESSING DEVICE AND NON-TRANSITORY COMPUTER READABLE MEDIUM

(71) Applicant: NIDEK CO., LTD., Aichi (JP)

(72) Inventors: Hirofumi Yogo, Aichi (JP); Naoki Takeno, Aichi (JP); Sasagu Tachibana, Aichi (JP)

(73) Assignee: NIDEK CO., LTD., Aichi (JP)

(21) Appl. No.: 19/547,700

(22) Filed: Feb. 24, 2026

Related U.S. Application Data
(63) Continuation of application No. PCT/JP2024/031170, filed on Aug. 30, 2024.

(30) Foreign Application Priority Data
Sep. 5, 2023 (JP) 2023-144029
Sep. 5, 2023 (JP) 2023-144030

(51) Int. Cl. G06T 7/00

(52) U.S. Cl. CPC G06T 7/0016; G06T 2207/10101; G06T 2207/30041

(57) ABSTRACT

An ophthalmologic image processing device: acquires a data set comprising a plurality of image data that are image data for an eye under examination and are ordered in time series; divides the data set into a plurality of subsets demarcated by several reference times; obtains, for each of the subsets, first change-over-time information indicating the change over time, from the reference time, in the tissue of the eye being examined; and acquires second change-over-time information by connecting the respective first change-over-time information for the respective subsets. In analysis processing, each of the subsets is determined based on an evaluation value for the change between the respective image data in the data set, so that the respective subsets do not include image data uncorrelated with the image data for the reference time.

### CROSS-REFERENCE TO RELATED APPLICATION

This application is a continuation of PCT International Application No. PCT/JP2024/031170, filed on Aug. 30, 2024, which claims priority under 35 U.S.C § 119(a) to Japanese Patent Application No. 2023-144029, filed on Sep. 5, 2023 and Japanese Patent Application No. 2023-144030, filed on Sep. 5, 2023. Each of the above applications is hereby expressly incorporated by reference, in its entirety, into the present application.

### BACKGROUND

### Technical Field

The disclosure relates to an ophthalmologic image processing program and a non-transitory computer readable medium.

### Description of Related Art

Conventionally, various studies have been conducted to image the retinal function. For example, Patent Document 1 discloses a device that captures OCT images before and after retinal stimulation by stimulation light and extracts intrinsic signals of the retina based on luminance changes in the OCT images before and after stimulation. Additionally, attempts are also known to extract intrinsic signals using fundus front images captured by a fundus camera or SLO, or cell-level retinal images (tomographic images or front images) captured by a device equipped with an adaptive optics system, rather than OCT images.

### PRIOR ART DOCUMENT(S)

### Patent Document(s)

[Patent Document 1] Japanese Patent Application Laid-Open Publication No. 2011-135933

(1) Since intrinsic signals are weak, the signals are susceptible to the influence of noise caused by an imaging system including an eye under examination and an imaging optical system, which poses a problem in ensuring the reliability of intrinsic signals. For example, when the SN ratio of the image data is low, the image data is susceptible to the influence of noise, and the noise occurs based on the movement of the eye under examination during imaging, the vibration of the imaging system, and the like. In response to this, the inventors of the present application worked on an analysis method that can suppress the influence of the noise caused by the imaging system and obtain more reliable signals.

(2) For example, the retinal stimulation by stimulation light may cause multiple responses with different timescales. Additionally, the flow velocities of the blood flowing through the blood vessels of the eye under examination differ for each region. In response to this, the inventors of the present application worked on a method for appropriately detecting multiple responses with different timescales and blood flow velocities while suppressing the burden on the examiner and the subject.

(3) In the fovea, optic disc, lesion area, and the vicinities thereof (hereinafter referred to as “feature region”), the morphology of tissue is not homogeneous. The accuracy of the intrinsic signals detected from such tissue is lower than the accuracy of the intrinsic signals detected from tissue with homogeneous morphology. In response to this, the inventors of the present application worked on an examination method that can obtain reliable signals even when tissue with non-homogeneous morphology is included in a portion or the entirety of the region to be analyzed.

The disclosure provides the following:
(1) a novel analysis method capable of suppressing the influence of the noise caused by an imaging system;
(2) appropriately detecting multiple responses with different timescales and blood flow velocities while suppressing the burden on the examiner and the subject;
(3) detecting reliable signals even when tissue with non-homogeneous morphology is included in a portion or the entirety of the region to be analyzed.

### SUMMARY

An aspect of the disclosure provides a non-transitory computer readable medium storing an ophthalmologic image processing program. When executed by a processor of an ophthalmologic image processing device, the ophthalmologic image processing program causes the ophthalmologic image processing device to execute: a dataset obtaining step of obtaining a dataset formed by a plurality of image data of an eye under examination ordered in time series; and an analysis processing step of dividing the dataset into a plurality of subsets demarcated by one or more reference times, obtaining first change-over-time information indicating over-time change of tissue of the eye under examination from the reference time for the respective subsets, and obtaining second change-over-time information by performing a connection process on the first change-over-time information of the respective subsets. The analysis processing step determines each of the subsets based on an evaluation value of change between the respective image data in the dataset, such that the respective subsets do not comprise image data uncorrelated with the image data at the reference time.

Another aspect of the disclosure provides an ophthalmologic image processing device, executing the ophthalmologic image processing program.

### BRIEF DESCRIPTION OF THE DRAWINGS

FIG. 1 is a block diagram showing a schematic configuration of an ophthalmologic information processing system 1 according to an embodiment.

FIG. 2 is a schematic diagram of an optical system according to an embodiment.

FIG. 3 is a flowchart showing a flow of an examination according to an embodiment.

FIG. 4 is a timing chart for describing a temporal relationship between light stimulation and imaging of OCT data in an examination according to an embodiment.

FIG. 5 is a diagram showing a stimulation range in a retina, an imaging range of OCT data, and a region of interest of ORG data.

FIG. 6 is a flowchart showing an analysis process of an embodiment.

FIG. 7 is a diagram for describing a layer region as a measurement target in a tomographic image of a retina, where a window is shown with a rectangle superimposed on the tomographic image.

FIG. 8 is a diagram showing time evolution of a reliability w(t,Δt).

FIG. 9 is an example of a weighted graph constructed based on time evolution of the reliability w(t,Δt).

FIG. 10 is a diagram for describing a KT-Path derived by a path search for a weighted graph, in which KT-Path(s) is superimposed on FIG. 8.

FIG. 11 is a diagram showing an analysis result by an analysis method of an embodiment.

FIG. 12 is a diagram showing a positional relationship among a stimulation range in a retina, an imaging range of OCT data, a region of interest of ORG data, and a reference region in a second embodiment.

FIG. 13 is a flowchart showing an analysis process of a second embodiment.

FIG. 14 is a diagram showing the positions of the region of interest and the reference region in a tomographic image of a retina, corresponding to FIG. 12.

FIG. 15 is an example of a weighted graph constructed in the analysis process of the second embodiment.

FIG. 16 is a diagram for describing a depth region suitable for setting the region of interest and the reference region in a modified example of FIG. 12 and FIG. 14.

FIG. 17 is a graph showing a model of time variation in the morphology of a photoreceptor outer segment in response to light stimulation, with a timescale adjusted to a fast response.

FIG. 18 is a graph showing FIG. 17 with a timescale adjusted to a fast response.

FIG. 19 is a diagram showing operation waveforms of a scanning unit in a third embodiment.

FIG. 20 is a diagram showing examination results superimposed on the graph showing the model of time variation in the morphology of the photoreceptor outer segment in response to the light stimulation shown in FIG. 18.

FIG. 21 is an example of a scan position setting screen in a fourth embodiment.

FIG. 22 is a diagram showing a positional relationship among a stimulation range on a retina, an imaging range of OCT data, a region of interest of ORG data, and a feature region in a fourth embodiment.

FIG. 23A is a diagram showing operation waveforms of a scanning unit corresponding to a first scanline shown in FIG. 21.

FIG. 23B is a diagram showing operation waveforms of a scanning unit corresponding to a second scanline shown in FIG. 21.

FIG. 24 is a diagram showing positions of a feature region and a region of interest in the second scanline shown in FIG. 21 on a tomographic image of a retina.

FIG. 25A is a first modified example of the weighted graph.

FIG. 25B is a second modified example of the weighted graph.

FIG. 25C is a third modified example of the weighted graph.

### DESCRIPTION OF THE EMBODIMENTS

(1) An ophthalmologic image processing program is provided according to the first aspect of the disclosure. When executed by a processor of an ophthalmologic image processing device, the ophthalmologic image processing program causes the ophthalmologic image processing device to execute: a dataset obtaining step of obtaining a dataset formed by multiple image data of an eye under examination, the image data being ordered in time series; and an analysis processing step of dividing the dataset into multiple subsets demarcated by several reference times, obtaining first change-over-time information indicating over-time change from the reference time of tissue of the eye under examination for each of the subsets, and obtaining second change-over-time information by performing a connection process on the first change-over-time information of each of the subsets. The analysis processing step determines each of the subsets based on an evaluation value of change between the respective image data in the dataset so that each of the subsets does not include image data uncorrelated with the image data at the reference time.

An ophthalmologic image processing device according to a second aspect of the disclosure executes the ophthalmologic image processing program according to the first aspect.

A third aspect of the disclosure provides an ophthalmologic image processing program. When executed by a processor of an ophthalmologic image processing device, the ophthalmologic image processing program causes the ophthalmologic image processing device to execute: a dataset obtaining step of obtaining a dataset that are multiple image data ordered in time series and includes image data of a fundus of a light-stimulated eye under examination; a region setting step of setting a region of interest for a first tissue that responds to a light stimulus and setting a reference region for a second tissue that has a smaller response to the light stimulus than the first tissue, in fundus tissue including a retina of the eye under examination in each of the image data; and an analysis processing step of obtaining an ORG signal of the tissue of the eye under examination in the region of interest by performing analysis processing on the dataset. In the analysis processing step, the ORG signal in the region of interest is obtained in which an over-time change component commonly occurring in the region of interest and the reference region is reduced, based on a portion of the image data in the reference region at each time.

An ophthalmologic image processing device according to a fourth aspect of the disclosure executes the ophthalmologic image processing program according to the third aspect.

(2) A fifth aspect of the disclosure provides an ophthalmologic image processing program. When executed by a processor of an ophthalmologic examination system, the ophthalmologic image processing program causes the ophthalmologic examination system to execute: a dataset obtaining step of obtaining a dataset formed by multiple image data ordered in time series as a result of repeatedly imaging a certain range in an eye under examination during an examination period through an imaging optical system, an interval of imaging time of each of the image data being adjusted according to elapsed time within the examination period; a time obtaining step of obtaining imaging time information indicating the imaging time of each of the image data included in the dataset; an analysis processing step of obtaining change-over-time information indicating a over-time change in a local region of the eye under examination during the examination period by analysis processing based on the dataset and the imaging time information; and a display control step of displaying the change-over-time information on a monitor.

A sixth aspect of the disclosure provides an ophthalmologic examination method implemented by a processor of an ophthalmologic examination system that analyzes over-time change of an eye under examination. The ophthalmologic examination system includes an irradiation optical system that irradiates the eye under examination with stimulation light, an imaging optical system that images the eye under examination, and a monitor. The method includes: irradiating the eye under examination with stimulation light via the irradiation optical system; repeatedly imaging a certain range of the eye under examination by controlling the imaging optical system during an examination period in which the stimulation light is irradiated over a portion or all of the period; obtaining a dataset formed by multiple image data ordered in time series, an interval of imaging time of each of the image data being adjusted according to elapsed time within the examination period; obtaining imaging time information indicating imaging time of each of the image data included in the dataset; obtaining change-over-time information indicating over-time change of a local region of the eye under examination during the examination period by analysis processing based on the dataset and the imaging time information timestamp; and displaying the change-over-time information on the monitor.

(3) A seventh aspect of the disclosure provides an ophthalmologic image processing program implemented by a processor of an ophthalmologic examination system that analyzes over-time change of an eye under examination. When the ophthalmologic image processing program is executed by the processor of the ophthalmologic examination system, the ophthalmologic examination system executes: a dataset obtaining step of obtaining, as a result of imaging, a dataset including multiple OCT data ordered in time series as a result of repeatedly imaging a certain range of the eye under examination via an OCT device during an examination period, a density of A-scan points in each of the OCT data differing according to a position on the fundus in a transverse direction; a region of interest setting step of setting a region of interest at a corresponding position among multiple OCT data included in the dataset; and an analysis processing step of obtaining change-over-time information indicating over-time change of tissue of the eye under examination in the region of interest by analysis processing that analyzes the dataset.

An eighth aspect of the disclosure provides an ophthalmologic examination method implemented by a processor of an ophthalmologic examination system that analyzes over-time change of an eye under examination is provided. The ophthalmologic examination system includes an irradiation optical system that irradiates the eye under examination with stimulation light, and an OCT device that scans measurement light on a fundus of the eye under examination and images OCT data of the fundus based on a spectral interference signal between return light of the measurement light and reference light. The method includes: irradiating the fundus of the eye under examination with the stimulation light via the irradiation optical system; repeatedly imaging OCT data of a certain imaging range irradiated with the stimulation light via the OCT device; obtaining, as a result of the imaging, a dataset including multiple OCT data ordered in time series, a density of A-scan points in each of the OCT data differing according to a position on the fundus in a transverse direction; setting a region of interest at a corresponding position among the multiple OCT data included in the dataset; and obtaining change-over-time information indicating over-time change of tissue of the eye under examination in the region of interest by analysis processing that analyzes the dataset.

### Overview

Embodiments according to the disclosure are described. Each embodiment can be applied to some or all of other embodiments. For example, items classified with below can be used independently or in association with each other.

### First Embodiment

An ophthalmologic image processing device according to the first embodiment executes at least a dataset obtaining step and an analysis processing step. An ophthalmologic image processing program for executing each step is stored in a non-transitory storage medium accessible by a processor of the ophthalmologic image processing device.

In the dataset obtaining step, the ophthalmologic image processing device obtains a dataset formed by multiple image data of an eye under examination that are are ordered in time series. The image data included in one dataset may be continuously captured at an interval less than one second. In addition, in the image data included in one dataset, imaging positions on the eye under examination may be the same.

For the image data of the eye under examination, any of various modalities can be appropriately utilized. For example, OCT data captured by an OCT device, frontal image data of the fundus captured by a fundus camera, SLO, or a slit scanning fundus imaging device, cell image data captured by OCT or SLO with wavefront compensation, and the like may be utilized as the image data of the eye under examination. However, those listed above are merely examples of the image data of the eye under examination, and the disclosure is not limited thereto.

In addition, in the following description, unless otherwise specified, the image data of the eye under examination is described as being obtained by imaging the retina of the eye under examination. However, the disclosure is not necessarily limited thereto. For example, the image data may be image data obtained by imaging parts other than the retina, such as the cornea, iris, crystalline lens, vitreous body, sclera, and the like.

In the analysis processing step, the ophthalmologic image processing device divides the dataset into multiple subsets demarcated by several reference times, and obtains first change-over-time information indicating the over-time change of tissue of the eye under examination from the reference time for each subset. For example, the ophthalmologic image processing device may obtain a change amount of the tissue in the image data at Δt after the reference time based at least on the image data at the reference time and the image data at Δt after the reference time, and may obtain the first change-over-time information in each subset by performing the process for each image data of the subset. Each subset may include multiple image data ordered in time series, starting with the image data at the reference time for each subset. In the following description, a case where the change amount of the tissue is obtained based on a change in phase of a corresponding region between image data is mainly described, but the disclosure is not necessarily limited thereto. For example, the change amount of the tissue may be obtained based on a change in the number of pixels, a change in intensity, and the like, of the corresponding tissue between image data.

In addition, the ophthalmologic image processing device obtains second change-over-time information by performing a connection process on the first change-over-time information of the respective subsets. The second change-over-time information indicates, for example, the over-time change of the tissue of the eye under examination during an obtaining period of the dataset. The connection process may be, for example, a process of summing or integrating the first change-over-time information corresponding to the respective subsets.

The image data at the reference time and the image data at Δt after the reference time generally have a correlation that decreases as time elapses (in other words, the larger Δt), and become uncorrelated at a sufficiently large Δt. Particularly in phase-based imaging, decorrelation occurs in a relatively short time. The decrease in correlation may occur based on, for example, random eye movement, morphological change of tissue, and vibration of the imaging system, and the like. The over-time change cannot be properly obtained from two image data with low correlation. Comparatively, in the embodiment, since the dataset is divided into multiple subsets demarcated by several reference times, the decrease in correlation with the passing of time from the reference time is easily suppressed. Highly reliable information is easily obtained as the first change-over-time information in each subset, and as a result, the reliability of the second change-over-time information is also improved.

The time until decorrelation varies due to the influence of the morphological change of tissue during imaging, the movement of the eye under examination, and the like. In addition, the time until decorrelation also varies depending on which of the image data included in the dataset is used as the image data at the reference time. Furthermore, the SN ratio of each image data also affects the time until decorrelation. For this reason, even when the dataset is divided at a predetermined constant time interval, it is difficult to avoid including image data uncorrelated with the image data at the reference time within a subset. Therefore, there may be cases where a proper analysis result (change-over-time information) cannot be obtained. Comparatively, the ophthalmologic image processing device of the embodiment, in the analysis processing step, determines each subset based on an evaluation value of change between respective image data in the dataset, so that image data uncorrelated with the image data at the reference time is not included in each subset. As the evaluation value of the change between the image data, for example, various image information such as the correlation, the phase difference, the luminance change, and the change in the number of pixels for the same tissue between image data may be used. Among these, particularly in the case where phase-based imaging is performed, it is desirable that the correlation or phase difference between image data is used as the evaluation value. In the case of determining the subsets based on the evaluation value (in the case of dividing the dataset), the intervals of the reference times are not necessarily constant, and furthermore, the number of the image data in each subset may differ from each other according to the interval of the reference time. In the embodiment, by using the evaluation value of the change between respective image data, it becomes possible to flexibly and appropriately divide the dataset. For this reason, proper analysis results (first change-over-time information and second change-over-time information) are easily obtained.

In particular, the ophthalmologic image processing device of the embodiment may, in the analysis processing step, construct a graph relating to the evaluation values of the change between respective image data in the dataset, and divide the dataset based on a path search on the graph. As a result of dividing the dataset based on the path search on the graph, the image data having a low correlation with the image data at the reference time becomes even less likely to be included within each subset. This further improves the reliability of the first change-over-time information and the second change-over-time information obtained from the respective subsets.

The graph constructed in the analysis processing step may have, for example, a graph structure representing the evaluation values between the respective image data included in the dataset. As an example, a graph may be constructed having a structure in which image data (first candidate image data) obtained at a candidate time that is a candidate for the reference time and image data (second candidate image data) for obtaining the over-time change from the candidate time are used as nodes, and each node is connected to temporally consecutive nodes. In this case, the cost corresponding to the evaluation value of each image data may be assigned between nodes. For example, in the case of using the phase information of the image data, the phase correlation or phase difference between two image data may be used as the cost, and for example, in the case where the pixel values (luminance values) of the image data are used, the correlation of pixel values, luminance change, and the like between two image data may be used as the cost.

### <Specific Example of Path Search Method>

As the method (algorithm) for path search on the graph, for example, an algorithm for solving the shortest path problem (for example, Dijkstra's algorithm, Bellman-Ford algorithm, Warshall-Floyd algorithm, etc.) may be used. Without being limited to this, the path search algorithm may be appropriately selected from any of various algorithms such as breadth-first search (best-first search, uniform cost search, A*), depth-first search, iterative deepening depth-first search, depth-limited search, bidirectional search, branch and bound method, beam search, and the like. However, those listed above are merely examples of the path search method, and the disclosure is not limited thereto.

<Optimization Methods Other than Path Search>

Also, the division of the dataset may be optimized without constructing a graph. For example, in the analysis processing step, using a bit array which corresponds to the dataset and represents the image data at the reference time and the other image data with different values, an optimal bit array may be identified by evaluating the bit array using an evaluation function relating to the evaluation value each time the bit array is changed, and the dataset may be divided according to the identified bit array. As such a method, any of brute force method, genetic algorithm, and the like may be appropriately selected as a method for changing the bit array. However, these methods are merely examples of methods for changing the bit array, and the disclosure is not limited thereto.

### <Application to Phase-Sensitive OCT>

As described above, the image data of the eye under examination in the dataset may be OCT data of the fundus of the eye under examination. In this case, the ophthalmologic image processing device may obtain the first change-over-time information and the second change-over-time information by obtaining the over-time change of the phase difference in the OCT data ordered in time series in the dataset.

### <Application to Optoretinography>

In the embodiment, the image data of the eye under examination in the dataset may include image data of the light-stimulated fundus. In this case, the ophthalmologic image processing device may obtain an ORG signal as the change-over-time information in the analysis processing step. The ORG signal is an intrinsic optical signal of the retina based on light stimulation.

### <Analysis Method Using Reference Region>

The ophthalmologic image processing device according to the first embodiment may further execute a region setting step. In the region setting step, the ophthalmologic image processing device may set a region of interest and a reference region for each image data. The region of interest is set for a first tissue on the retina that responds to light stimulation. The reference region is set for a second tissue on the retina that has a smaller response to light stimulation than the first tissue

In this case, the ophthalmologic image processing device constructs a graph based on a portion of the image data in the reference region at each time in the analysis processing step. The dataset is divided into multiple subsets based on path search for the graph. Furthermore, the ophthalmologic image processing device obtains the first change-over-time information by processing the portion of the image data included in the region of interest at each time in each subset. Furthermore, the second change-over-time information may be obtained by performing the connection process on the first change-over-time information of the respective subsets at the reference time.

Accordingly, the first change-over-time information and the second change-over-time information in which the over-time change component commonly occurring in the region of interest and the reference region is reduced can be obtained. Therefore, the reliability of the first change-over-time information and the second change-over-time information can be further improved.

### Second Embodiment

The ophthalmologic image processing device according to the second embodiment executes at least a dataset obtaining step, a region setting step, and an analysis processing step

In the dataset obtaining step, the ophthalmologic image processing device obtains a dataset including multiple image data ordered in time series, the image data being fundus image data of a light-stimulated eye under examination. As for the fundus image data, similar to the first embodiment, any of OCT data, frontal image data, cell image data, and the like can be appropriately used.

In the region setting step, the ophthalmologic image processing device may set the region of interest and the reference region for each image data. The region of interest is set for the first tissue on the retina that responds to light stimulation. The reference region is set for the second tissue on the retina that has a smaller response to light stimulation than the first tissue.

For example, the reference region may be set with tissue located outside the irradiation range of the stimulation light in the light stimulation as the second tissue. Furthermore, in the case where the image data is the OCT data of the fundus, the reference region may be set for a layer region different from the region of interest. In this case, it is desirable that the layer region where the reference region is set is a layer region that is not affected by layer thickness change based on the light stimulation in the region of interest.

In the analysis processing step, the ophthalmologic image processing device obtains an ORG signal of the tissue of the eye under examination in the region of interest by performing analysis processing on the dataset. In particular, in the second embodiment, through the analysis processing, an ORG signal in the region of interest is obtained in which the over-time change component commonly occurring in the region of interest and the reference region is reduced based on the portion of the image data in the reference region at each time.

For example, as described in the first embodiment, the dataset may be divided into multiple subsets demarcated by several reference times, the first change-over-time information (first ORG signal) indicating the over-time change from the reference time of the tissue of the eye under examination may be obtained for each subset, and second change-over-time information (second ORG signal) may be obtained by performing the connection process on the first change-over-time information (first ORG signal) obtained for the respective subsets. For example, similar to the first embodiment, it may be that a graph is constructed based on a portion of the image data in the reference region, and the reference time for dividing the dataset may be determined based on the path search on the graph. However, the disclosure is not necessarily limited thereto, and multiple subsets may be obtained by equally dividing the dataset by a predetermined number. In this case, an evaluation value (for example, correlation, phase difference, etc.) indicating a change from the image data at the reference time in the reference region may be obtained for the image data at each time in the subset, and the first ORG signal may be corrected, or the connection process may be performed, by using a weight according to the evaluation value. For example, in the case of obtaining the first ORG signal in the subset as a weighted moving average of the over-time change at each time, the calculation may be performed with the weight according to the evaluation value. Furthermore, for example, in the case of using correlation as the evaluation value, for times where the correlation is equal to or less than a threshold, interpolation may be performed by using data obtained at preceding and following times. Furthermore, for example, the difference between the information indicating the over-time change of the tissue obtained based on the portion of the image data in the region of interest and the information indicating the over-time change of the tissue obtained based on the portion of the image data in the reference region may be obtained as the ORG signal.

### Third Embodiment

The ophthalmologic examination system according to the third embodiment executes at least a dataset obtaining step, a time obtaining step, an analysis processing step, and a display control step.

The ophthalmologic examination system may additionally execute at least one of an imaging control step and a light stimulation step. The ophthalmologic image processing program for executing each step is stored in a non-transitory storage medium accessible by a processor of the ophthalmologic examination system.

The ophthalmologic examination system according to the third embodiment includes at least an ophthalmologic image processing device. The ophthalmologic examination system may further include an ophthalmologic examination device. The ophthalmologic examination device has at least one of a function of light stimulation to the eye under examination and a function of imaging the eye under examination. In the ophthalmologic examination system, the ophthalmologic image processing device and the ophthalmologic examination device may be integrated. The ophthalmologic examination system includes one or multiple processors, and the one or multiple processors may cooperate to execute each of the above steps.

### <Dataset Obtaining Step>

In the dataset obtaining step, the ophthalmologic examination system obtains a dataset formed by multiple image data ordered in time series, as a result of repeatedly imaging a certain range of the eye under examination through the imaging optical system during the examination period. In the third embodiment, in the dataset obtained in the dataset obtaining step, the interval of the imaging time of the respective image data is adjusted according to the elapsed time within the examination period. For example, the examination period may be divided into several intervals. Specifically, the examination period may include at least a first interval and a second interval having an elapsed time different from the first interval. In this case, for example, a dataset adjusted such that the intervals of the imaging time differ between multiple image data corresponding to the first interval and multiple image data corresponding to the second interval may be obtained by the ophthalmologic examination system. The examination period may also include three or more intervals. In the dataset, the interval of the imaging time of multiple image data corresponding to a third interval having an elapsed time different from both the first interval and the second interval may differ from the image data corresponding to either the first interval or the second interval. Additionally, it is not necessarily required that the intervals of the imaging time of the image data be adjusted to differ by using interval as a unit. For example, the interval of the imaging time may be adjusted to differ by using an image data unit.

For example, in the case of light stimulation of the retina, it is desirable that the interval of the imaging time in each image data be set according to the timescale of the change in tissue (an example of local region). In this case, a large change occurs in the tissue within a short time immediately after the light stimulation, and thereafter, the change proceeds gradually.

Comparatively, among the image data included in the dataset, the time interval is set to be short for those captured within a certain time immediately after the stimulation, and the time interval is set to be long for those captured after a certain time has elapsed, thereby obtaining a dataset including image data captured at an appropriate time interval with respect to the change in the tissue.

As for the image data of the fundus, similar to the first embodiment, any of OCT data, frontal image data, and cell image data, etc., can be appropriately utilized.

### <Time Obtaining Step>

The ophthalmologic examination system obtains the imaging time information indicating the imaging time of each image data included in the dataset in the time obtaining step. The imaging time information may be obtained, for example, at the timing when the image data is captured, for example, by referring to a built-in clock. The imaging time information may be a so-called timestamp. The imaging time information may be stored in the file of each image data as meta information. Also, for example, the imaging time information may be a data table that associates, for each image data, the identification information of the image data with the imaging time of the image data. In this case, the imaging time information is obtained as a separate file from the image data.

### <Analysis Processing Step>

The ophthalmologic examination system obtains the change-over-time information indicating the over-time change of the eye under examination during the examination period through analysis processing based on the dataset and the imaging time information in the analysis processing step. In the analysis processing, at least the change in information between the image data at the interval of imaging time specified by the imaging time information is obtained. For example, the change-over-time information may indicate a change related to tissue thickness. However, the disclosure is not necessarily limited thereto, and the change-over-time information may indicate other changes in the local region.

In the embodiment, the change-over-time information indicating the over-time change of the eye under examination during the examination period is obtained as the result of the analysis processing that analyzes the dataset formed of multiple image data ordered in time series. At this time, in the embodiment, the interval of the imaging time of each image data is adjusted at least according to the elapsed time within the examination period. In other words, the interval of imaging time of image data is not uniform throughout the entire dataset. Comparatively, in the embodiment, analysis processing is performed by obtaining and utilizing the imaging time information indicating the imaging time of each image data included in the dataset. Accordingly, the change of the eye under examination at each imaging time to be appropriately obtained, and as a result, the change-over-time information indicating the over-time change of the eye under examination during the examination period can be obtained with high accuracy.

### <Application to Optoretinography>

The ophthalmologic examination system according to the third embodiment may be utilized for optoretinography. In this case, the image data of the eye under examination in the dataset may include the image data of the light-stimulated fundus. Also, in the analysis processing step, an ORG signal is obtained as the change-over-time information.

Here, in the case where the retina is light-stimulated, a significant change occurs in the tissue within a short time immediately after light stimulation, and thereafter, the change becomes gradual. Therefore, in the third embodiment, the interval of the imaging time may be set short immediately after the light stimulation starts, and thereafter, the interval of the imaging time may be set long. In this case, the ORG signal with an appropriate temporal resolution for the tissue change at each timing can be easily obtained.

Also, in optoretinography, dark adaptation is required before the examination, but in the third embodiment, the preparation for the examination such as dark adaptation and alignment for multiple responses with different timescales can be completed in one session, so the time required for the examination can be significantly reduced. As a result, the burden on the examiner and the subject can be reduced.

In the case where the ophthalmologic examination device is a device that images the eye under examination, the ophthalmologic examination system may further execute an imaging control step. In the imaging control step, the ophthalmologic examination system changes the interval of the imaging time at least according to the elapsed time in the examination period by controlling the imaging optical system. In parallel, the ophthalmologic examination system continuously and repeatedly images a predetermined region via the imaging optical system. In this case, the interval of the imaging time of each image data in the dataset obtained in the dataset obtaining step can be easily set freely.

The method for obtaining a dataset in which the interval of the imaging time of each image data is adjusted according to the elapsed time within the examination period is not limited to the above imaging control. For example, in the imaging optical system, the image data may be repeatedly captured at a constant time interval regardless of the elapsed time. In this case, by partially thinning out the image data obtained by imaging, the interval of the imaging time of each image data included in the dataset may be adjusted at least according to the elapsed time in the examination period.

### <Application to Intra B-scan DOCT>

The third embodiment is applicable to Intra B-scan DOCT (Doppler OCT). In particular, it is useful for obtaining blood flow information in large blood vessels. In this case, the ophthalmologic examination system includes at least an OCT device and obtains OCT data of the eye under examination. Also, in the analysis step in Intra B-scan DOCT, the flow velocity of blood flow is measured based on the phase difference of adjacent A-scans. Here, in the disclosure, the interval of the imaging time of each OCT data is adjusted according to the elapsed time within the examination period. That is, the interval of the time of obtaining flow velocity is changed according to the elapsed time. For example, even when measurement is performed on a blood vessel with unknown blood flow velocity, measurement can be easily performed with time resolution suitable for the flow velocity in a portion of the dataset. Also, if the blood flow velocity in each region is known, the interval of the imaging time of OCT data (here, B-scan) may be made different between a first local region and a second local region having a higher blood flow velocity than the first local region. Specifically, the interval of the imaging time for the second local region may be made shorter than the interval of the imaging time for the first local region. By doing so, by increasing the frame rate for regions with high flow velocity, measurement can be performed with a time resolution suitable for such flow velocity, and noise can also be reduced, and by decreasing the frame rate for regions with low flow velocity, unnecessary data can be prevented from being obtained.

### <Multiple Preset Values Related to Time Interval and Method for Selecting Preset Values>

At least one of the number of intervals for the examination period, the length of each interval, and the interval of the imaging time in each interval (hereinafter referred to as “interval information”) may be changeable. For example, multiple interval information may be prepared in advance as preset values. For example, preset values may be prepared for respective types of tissues to be examined, may be prepared for each feature of tissue, or may be prepared for each disease type in the eye under examination. Also, the preset values may be prepared for each combination of the aforementioned. In this case, for example, a preset value may be automatically selected according to the type or the feature of the tissue present at the obtaining position of OCT data or the position of the region of interest to be subjected to analysis processing, or according to the disease type in the eye under examination. Also, one of multiple preset values prepared in advance for each tissue may be selected via the user interface.

However, in the future, if analysis processing can be performed in real time during the examination and changes in tissue can be detected in real time, the speed of tissue changes may be fed back at the interval of imaging time as needed. That is, when data with rapid changes is obtained, the frame rate may be increased, and conversely, when data with slow changes is obtained, the frame rate may be decreased.

### Fourth Embodiment

The ophthalmologic examination system according to the fourth embodiment executes at least a dataset obtaining step and an analysis processing step. The ophthalmologic examination system may additionally execute at least one of an imaging control step, a light stimulation step, and a display control step. An ophthalmologic image processing program for executing each step is stored in a non-transitory storage medium accessible by a processor of the ophthalmologic examination system.

The ophthalmologic examination system according to the fourth embodiment includes at least an ophthalmologic image processing device.

The ophthalmologic examination system according to the fourth embodiment may include an irradiation optical system. The irradiation optical system is used for light stimulation to the eye under examination. The irradiation optical system irradiates stimulation light to the eye under examination.

In the ophthalmologic examination system, the ophthalmologic image processing device and the OCT device may be integrated. The ophthalmologic examination system may include one or multiple processors, and the one or multiple processors may cooperate to perform each of the above steps.

### <Imaging Control Step and Dataset Obtaining Step>

The ophthalmologic examination system according to the fourth embodiment, in the imaging control step, repeatedly captures OCT data of a certain imaging range in the fundus via the OCT device.

In the dataset obtaining step, a dataset formed by multiple OCT data ordered in an imaging time series is obtained as a result of imaging. In each OCT data included in the dataset, the density of A-scan points differs according to the position on the fundus in the transverse direction. An A-scan point is an obtaining position of A-scan OCT data.

For example, in the imaging control step, the density of A-scan points may be varied according to the position on the fundus in the transverse direction by sampling each A-scan OCT data while changing the scan speed of measurement light relative to the fundus during imaging. When changing the scan speed of measurement light on the fundus, the OCT device scans the measurement light on the fundus. In this case, the scan method in the OCT device may be a point-scan method or a line-scan method. Additionally, the OCT device may include an optical scanner such as a galvanometer scanner.

Additionally, after scanning the measurement light and sampling A-scan OCT data in the imaging range, the density of A-scan points in the OCT data may be adjusted according to the position on the fundus in the transverse direction by thinning out the A-scan OCT data according to the position on the fundus in the transverse direction.

The density of A-scan points in the OCT data may be set according to the positional relationship between the obtaining position of the OCT data and the position of the feature region. For example, A-scan points may be set at different densities between the feature region and the outer region thereof. As an example, A-scan points may be set densely (high density) in the feature region in the fundus, and set sparsely (low density) outside the feature region. Conversely, A-scan points may be set sparsely (low density) in the feature region in the fundus, and set densely (high density) outside the feature region. The feature region may be a region where the morphology of tissue differs from the surroundings. The optic disc, fovea, blood vessels, lesions, abnormal sites, and the vicinity of each are given as examples of the feature region.

### <Region of Interest Setting Step>

The ophthalmologic examination system according to the fourth embodiment sets a region of interest, which is the analysis target in the analysis processing described later, for multiple OCT data included in the dataset. The region of interest is set at a corresponding position between the respective OCT data. For example, the region of interest may be automatically set at a predetermined position in the OCT data. Additionally, the region of interest may be manually set via an ophthalmologic image showing the imaging range of the eye under examination. The ophthalmologic image may be, for example, any of the OCT data included in the dataset, or may be frontal image data including the imaging range. The ophthalmologic image is displayed on a monitor, and the region of interest is set based on a position designated on the ophthalmologic image via the user interface.

### <Analysis Processing Step>

The ophthalmologic examination system according to the fourth embodiment obtains change-over-time information indicating the over-time change of the tissue of the eye under examination in the region of interest through analysis processing that analyzes the dataset. The change amount in the tissue may be obtained based on the change in phase of the OCT data in the region of interest, the change in intensity, the change in the number of pixels in the segmented region, and the like.

Here, since the morphology of tissue is not homogeneous at the fovea, optic disc, lesion sites, and the vicinity thereof, when the tissue is included in the region of interest that is the target of the analysis processing, large errors tend to occur in the change-over-time information obtained as a result of the analysis processing.

Comparatively, in the fourth embodiment, in each OCT data included in the dataset, the density of A-scan points differs depending on the position on the fundus in the transverse direction, so the change-over-time information can be easily obtained with high accuracy. For example, in the case where the region of interest includes a feature region, it is desirable that the density of A-scan points differs between the feature region and the outer region thereof in the OCT data. In this case, if the density of A-scan points in the feature region is dense (high density) relative to the outer region, the change-over-time information in the feature region can be easily obtained with high accuracy. In the feature region as described above, the length of each part of the retinal tissue, such as the length of the outer segment, varies significantly. In such a feature region, due to the influence of fixational eye movements and the like, the tissue thickness information estimated from the OCT data also tends to have a significant variation (variance) among each OCT data. Comparatively, by increasing the density of A-scan points, the variance can be reduced, and as a result, the ORG signal, which is the over-time variation of the thickness information, can also be obtained with high accuracy in the feature region.

On the other hand, if the density of A-scan points in the feature region is sparse (low density) relative to the outer region, the change-over-time information in the outer region can be easily obtained with high accuracy. In addition, the measurement time can be easily shortened. As a result, the burden on the subject can be easily suppressed, and the stability of fixation can be easily improved. Whether the density of A-scan points in the feature region is set to be dense (high density) or sparse (low density) relative to the outer region may be appropriately set according to the purpose of the analysis processing.

In the analysis processing, by setting the region of interest for the analysis processing for each local region having a different position on the fundus in the transverse direction and analyzing the dataset, the change-over-time information for each local region may be obtained. Here, the local regions having different positions in the transverse direction may be set for each of two or more feature regions of different types, or for each of one or more feature regions and one or more outer regions. The density of A-scan points set for each region of interest may differ from each other. If the density of A-scan points is appropriately set for each region of interest, the change-over-time information in each local region can all be obtained with high accuracy.

### <Density Setting of A-Scan Points Using Fundus Image>

In addition, the ophthalmologic examination system in the fourth embodiment may set the density of A-scan points at each position of the fundus based on a fundus image of the eye under examination captured in advance

The fundus image of the eye under examination may be, for example, a tomographic image (in other words, a B-scan image) or a fundus frontal image. The fundus image may be generated based on OCT data captured by an OCT device. In addition, the fundus frontal image may be captured by a fundus camera, SLO, or the like.

In this case, by performing image processing on the fundus image, the feature region (and/or the outer region) may be detected, and different densities may be set between the feature region and the outer region. At this time, the density value corresponding to each region may be predetermined. Any of various conventional methods may be used for the image processing to detect the feature region.

In addition, the density of A-scan points at each position of the fundus may be set by inputting the density of A-scan points for each position of the fundus image via a user interface. In this case, for example, after detecting the feature region (and/or the outer region) by image processing, the density for each region may be input via the user interface. In addition, it may be possible to designate at least one local region as a region of interest at an arbitrary position of the fundus image via the user interface, and inputs of different densities may be received via the user interface between the region of interest and the outer region of the region of interest, or among multiple regions of interest. In inputting the density of A-scan points or the position of the region of interest via the user interface, the ophthalmologic examination system may display the fundus image via a display and accept input via the displayed fundus image.

### <Obtaining of Position Information of Feature Region>

The ophthalmologic examination system may obtain the position information of the feature region in advance in setting the density of A-scan points at each position of the fundus. For example, the position information of the feature region may be detected based on detection processing on the fundus image. The image type used for position detection of the feature region and the content of the processing (image processing or analysis processing) used for detection can be appropriately selected according to the type of the feature region. In addition, the position of the feature region may be input via the user interface. A fundus image including the feature region may be displayed upon input. By specifying the position on the fundus image via the user interface, the position information of the feature region is input and obtained by the ophthalmologic examination system.

When a fundus image is displayed in setting the obtaining position of OCT data or the position of the region of interest, the feature region may be highlighted in the fundus image. Accordingly, the obtaining position of OCT data or the position of the region of interest can be at a desired position with respect to the feature region.

In the present disclosure, the term “processor” refers to a single or multiple processors as hardware configured to execute program code (i.e., one or more instructions of a program) included in a program. In other words, a “processor” is a hardware device capable of executing one or more programmed processes. For example, a “processor” may be a general-purpose or special-purpose processor, such as a CPU, a microprocessor, a GPU, and a DFP (data flow processor), but is not limited thereto.

In the present disclosure, the term “memory” refers to a non-transitory tangible recording medium, indicating one or more hardware memories configured to record computer program code and/or data so as to be accessible from a processor. “Memory” may be realized by memory technologies such as SRAM, SDRAM, non-volatile/flash type memory, or other types of memory. Computer program code constituting a program is recorded on the memory and executed by the processor, thereby enabling the ophthalmologic image processing device or the ophthalmologic examination system to realize various functions.

### EXAMPLES

Hereinafter, examples according to each embodiment will be described based on the drawings.

The ophthalmologic information processing system 1 according to the present example is used for examining the function of the retina of the eye under examination. In the present example, as an example of the examination, imaging of an intrinsic optical signal (IOS) of the retina (referred to as optoretinography (ORG)) is performed. IOS may be referred to as an ORG signal. The examination method of the present example may be referred to as phase-based ORG because it visualizes the intrinsic optical signal based on phase information.

In addition, OCT imaging based on phase information may be referred to as phase-sensitive OCT. The optical path length of neurons and photoreceptors in the retina changes by, for example, several tens to several hundreds of nanometers upon activation due to light stimulation. However, general OCT systems do not have sufficient pixel resolution to detect the change. On the other hand, minute changes in the optical path length in the retina are reflected in the phase of the OCT signal. Therefore, phase-sensitive OCT enables measurement even of minute changes in tissue that are difficult to depict as pixel changes.

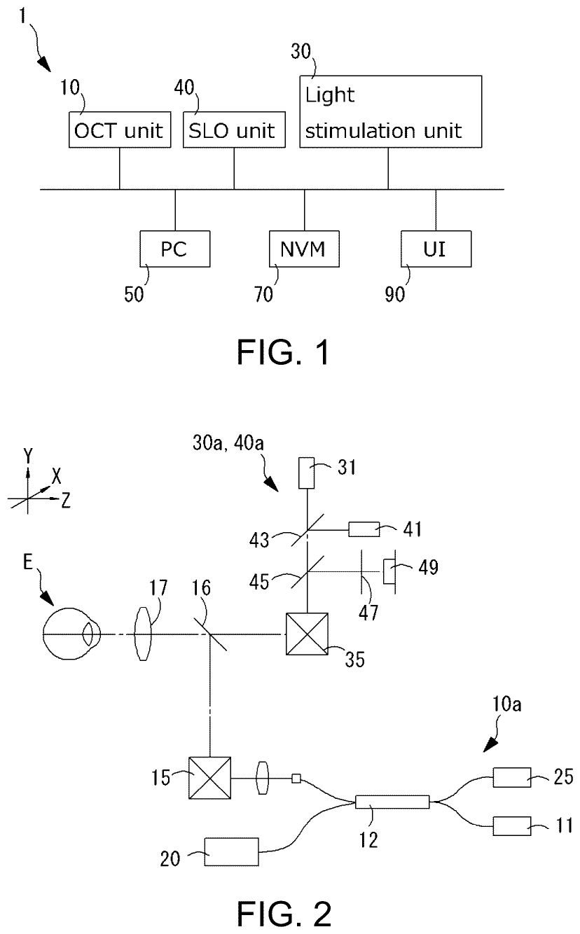

FIG. 1 shows a schematic configuration of the ophthalmologic information processing system 1 according to the present example. The ophthalmologic information processing system 1 of the present example includes an OCT unit 10, a light stimulation unit 30, an SLO unit 40, an arithmetic control unit 50, a storage device 70, and a user interface 90.

The arithmetic control unit 50 is the ophthalmologic image processing device in the present example. The arithmetic control unit 50 includes a central processing unit (CPU, processor), a random-access memory (RAM), a read-only memory (ROM), and the like. The arithmetic control unit 50 performs analysis processing of OCT data of the eye under examination obtained via the OCT unit 10. In addition, the arithmetic control unit 50 also serves as the control unit for the entire ophthalmologic information processing system 1.

The storage device 70 is a non-transitory storage medium (NVM) capable of retaining stored contents even when power supply is cut off. In the present example, the storage device 70 stores various control and analysis programs, fixed data, and the like.

The user interface 90 includes a display device and an operation input unit.

### <OCT Unit>

The OCT unit 10 is provided to obtain OCT data of the fundus of the eye under examination using optical interference technology.

The OCT unit 10 includes at least an OCT optical system 10a described later. In the present example, the OCT unit 10 is a swept-source OCT (SS-OCT), which is a type of Fourier domain OCT. However, the OCT unit 10 is not necessarily limited to this, and may be, for example, either a spectral-domain OCT (SD-OCT) or a time-domain OCT (TD-OCT). In addition, the OCT unit 10 in the present example is a point-scan method that two-dimensionally scans point-shaped measurement light on tissue, but is not necessarily limited to this, and other scan methods such as line-scan method, full-field method, and the like may be adopted.

### <Light Stimulation Unit>

The light stimulation unit 30 irradiates stimulation light onto the fundus of the eye under examination. The light stimulation unit 30 includes at least a stimulation light irradiation optical system 30a. The stimulation light is light of a wavelength band different from the measurement light and is used for fundus stimulation. Unless otherwise specified, the stimulation light is visible light. In the present example, the stimulation light is assumed to be white light of a wavelength band of λ=wavelength 400 nm to wavelength 800 nm. Stimulation parameters such as the wavelength band, intensity, and stimulation time of the stimulation light can be appropriately set within a range in which desired photobleaching occurs.

### <SLO Unit>

The SLO unit 40 is used for capturing a fundus frontal image (an example of a fundus image) of the eye under examination. The SLO unit 40 includes at least a frontal imaging optical system 40a. A fundus frontal image of the eye under examination is captured through the frontal imaging optical system 40a. In the present example, at least a fundus frontal image is captured as an observation image using infrared light. Additionally, a color fundus image using visible light may be captured. The fundus frontal image may be used for, for example, at least one of setting a scan position in OCT and tracking.

As described later, in the present example, the light stimulation unit 30 and the SLO unit 40 share at least a portion of the configurations.

Here, with reference to FIG. 2, the optical system included in the ophthalmologic information processing system 1 will be described.

### <OCT Optical System>

The OCT optical system 10a irradiates measurement light onto the fundus of the eye under examination and detects a spectral interference signal between the measurement light and the reference light. As a result of the spectral interference signal being processed by the arithmetic control unit 50, the OCT data of the fundus of the eye under examination is obtained.

The OCT optical system 10a of the present example mainly includes an OCT light source 11 (measurement light source), a coupler 14, a detector 25, and a scanning unit (optical scanner) 15. Furthermore, the OCT optical system 10a of the present example includes a dichroic mirror 16 and an objective lens 17 between the scanning unit 15 and the eye under examination.

In the present example, the OCT light source 11 is a wavelength swept light source (SS-OCT light source). As the OCT light source 11, a light source that emits light having a center wavelength between λ=1000 nm to 1100 nm may be used. The wavelength band is less likely to cause the measurement light to be absorbed in the transparent medium, and is easy to separate from other light such as stimulation light in terms of wavelength. As an example, a wavelength swept light source with a center wavelength of λ=1060 nm and a sweep frequency (A-scan rate) of 200 kHz is used. In this case, since the measurement light is in an invisible region for the eye under examination, it becomes difficult for the eye under examination to follow the optical scanning by the OCT optical system 10a. Therefore, OCT data can be obtained in a state where fixation of the eye under examination is stable, and as a result, good OCT data can be obtained.

The light from the OCT light source 11 is split into measurement light and reference light by the coupler 14. The measurement light is guided to a fundus Ef through a measurement optical path, and then guided to the detector 25 by traveling back through the measurement optical path. The reference light is guided to a reference optical system 20. The reference optical system 20 forms a reference optical path. In the present example, the reference optical system 20 is a reflective optical system in which a mirror (not shown) is disposed. The reference light is reflected by the mirror and guided to the detector 25. However, the reference optical system 20 may be a transmissive optical system.

The detector 25 detects an interference state between the measurement light irradiated onto the fundus of the eye under examination and the reference light as a spectral interference signal. The detector 25 may be a balanced detector. In the case of Fourier domain OCT, a complex OCT signal is obtained by Fourier transform of the spectral interference signal.

By calculating the absolute value of the amplitude in each complex OCT signal, a depth profile based on the intensity of the OCT signal is obtained. By arranging the depth profiles obtained at respective scan points, an OCT image (may also be referred to as an intensity OCT image) in which each pixel is represented by an intensity value is generated.

Also, by arranging the complex OCT signal obtained at each scan point, an OCT image in which each pixel is represented by a complex number (sometimes referred to as a complex OCT image) is generated.

The scanning unit 15 is disposed in the measurement optical path and scans the measurement light on the fundus of the eye under examination. In the present example, the scanning unit 15 scans the measurement light in an arbitrary transverse direction on the fundus. Also, the scanning unit 15 may repeatedly scan the measurement light on the eye under examination E. Based on signals from the detector 25 at each scan position of the scanning unit 15, OCT data at each scan position is obtained.

### <Stimulation Light Irradiation Optical System>

In the present example, the light stimulation unit 30 includes a stimulation light irradiation optical system 30a. The stimulation light irradiation optical system 30a irradiates a light stimulus onto a stimulation range set on the fundus.

For example, the stimulation light irradiation optical system 30a mainly includes a light source 31 and a scanning unit 35.

The light source 31 emits a light stimulus. As an example, a white LED may be used for the light source 31.

The scanning unit 35 is disposed in the optical path of the stimulation light irradiation optical system 30a (for example, at a pupil conjugate position). The light stimulus is deflected by the scanning unit 35 so that the light stimulus is irradiated onto the stimulation range set on the fundus. The scanning unit 35 may be realized by, for example, a combination of two optical scanners having mutually different scanning directions.

### <Frontal Imaging Optical System>

The frontal imaging optical system 40a irradiates illumination light onto the fundus of the eye under examination and captures a fundus frontal image based on the fundus reflection light of the illumination light.

The frontal imaging optical system 40a of the present example mainly includes an infrared light source 41 (illumination light source), beam splitters 43, 45, a filter 47, and a detector 49. Furthermore, the frontal imaging optical system 40a of the present example includes a scanning unit 35, the dichroic mirror 16, and the objective lens 17 between the beam splitter 43 and the eye under examination.

The irradiation optical system irradiates observation light onto the imaging site of the eye under examination. The light receiving optical system receives the fundus reflection light from the observation light by using the light receiving element 39. Observation images are sequentially obtained based on the output signal from the light receiving element 30. The scanning unit 35 two-dimensionally scans light on the fundus of the eye under examination. The scanning unit 35 may include, for example, a combination of a polygon mirror and a galvano scanner.

The observation light from the light source 41 passes through the beam splitters 43, 45, and then reaches the scanning unit 35 via the focusing lens 34. The light that has passed through the scanning unit 35 passes through the dichroic mirror 16, and then is irradiated onto the fundus of the eye under examination via the objective lens 17. The fundus reflection light is guided back along the path at the time of light projection to the beam splitter 45, is guided to the optical path on the reflection side in FIG. 2, and is received by the light receiving element 49. Based on the light receiving signal from the light receiving element 49, a frontal image of the imaging site is formed. The filter 47 cuts the light stimulus when obtaining an observation image simultaneously with the light stimulus. However, by alternately performing light stimulation and obtaining of the observation image in a time-division manner, the light stimulation and the obtaining of the observation image may be performed substantially simultaneously. In this case, the filter 47 may be omitted.

### <OCT-ORG Examination>

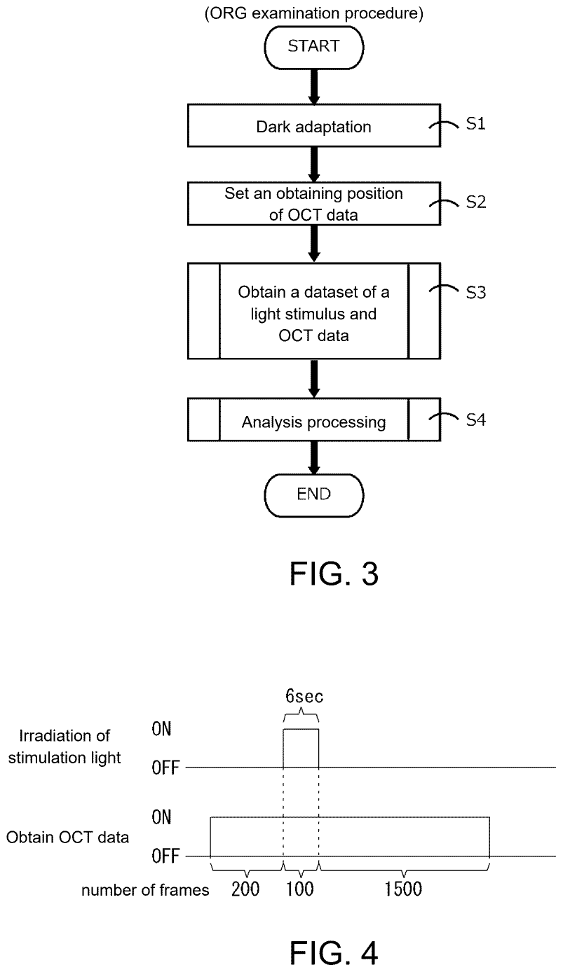

Next, with reference to FIG. 3 to FIG. 5, the details of the examination using the ophthalmologic information processing system 1 will be described.

In the following, the procedure when an animal eye (rabbit eye) is used as the eye under examination will be described, but it is considered that there is no significant difference in the procedure even in the case where a human eye is under examination. Nevertheless, the examination conditions may be appropriately changed to suit the human eye.

In the present example, the fundus of the eye under examination is light-stimulated, and the OCT data of the fundus is continuously obtained in each period before light stimulation, during light stimulation, and after light stimulation. By analyzing multiple OCT data continuously obtained, the information regarding functional activity in the retina of the eye under examination is obtained.

### <Examination Procedure>

FIG. 3 shows a flowchart representing the procedure of the entire examination.

At the time of examination, the eye under examination is sufficiently dark-adapted (S1).

For example, for experimental animals, general anesthesia and muscle relaxant treatment are administered, contact lenses are fitted, and dark adaptation is performed for 20 minutes.

Next, the obtaining position (scan position) of the OCT data is set (S2). For example, on the display device, a fundus frontal image is displayed, and a graphic indicating the scan position (scanline) is superimposed on the fundus frontal image. An operation for moving the position of the scanline may be inputtable, and the scan position on the fundus may be changeable based on the operation. Also, the scan position may be predetermined with respect to the fundus.

Next, light stimulation is applied to the eye under examination, and a dataset of OCT data is obtained (S3). The dataset of OCT data is formed by multiple OCT data (B-scans) captured at consecutive times. Each OCT data is ordered in time series by a timestamp (an example of imaging time information) indicating the imaging date and time. The arithmetic control unit 50 may obtain a timestamp corresponding to each OCT data by referring to a clock (not shown) each time one frame of OCT data is captured. In the present example, the arithmetic control unit 50 controls the OCT unit 10 to repeatedly obtain OCT data (B-scans) at the same scanline, thereby obtaining a dataset.

Here, the obtaining period of OCT data and the irradiation timing of the stimulation light are described using the timing chart of FIG. 4.

As shown in FIG. 4, obtaining of OCT data is started before the stimulus. During the obtaining period of the dataset, stimulation light is irradiated. As shown in FIG. 4, the stimulation light is continuously irradiated for 6 seconds. The light intensity of the stimulation light is adjusted in advance so that the fundus bleaching level reaches 63% as a result of the 6-second light stimulus.

In the present example, the OCT data (B-scan) are repeatedly obtained at 60-millisecond intervals. In this case, the OCT data are obtained at 200 frames (12 seconds) before light stimulation, 100 frames (6 seconds) during light stimulation, and 1500 frames (90 seconds) after light stimulation, respectively. However, the examination conditions such as the stimulus conditions and the obtaining rate of OCT data are merely examples and can be changed as appropriate. When the obtaining of the dataset is completed, the obtained dataset is stored in the storage device 70.

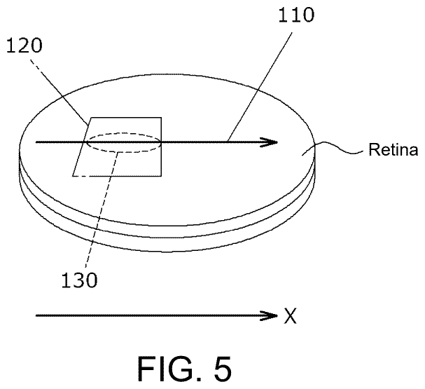

FIG. 5 shows the positional relationship between the obtaining range of OCT data and

the stimulation range on the fundus. The obtaining range of OCT data is indicated by the scanline 110. The obtaining range of OCT data and the stimulation range 120 overlap at least partially. In the present example, a region of interest (ROI) 130 for analysis processing is set in a portion included in the stimulation range among the OCT data, and information regarding the functional activity of the region of interest 130 is obtained.

In the present example, after the light stimulation and the obtaining of the dataset are completed, analysis processing is executed on multiple OCT data included in the dataset, and ORG data is obtained (S4).

The ORG data may be image data that visualizes the ORG signal obtained by processing multiple OCT data, or may be data indicating the over-time change of the ORG signal.

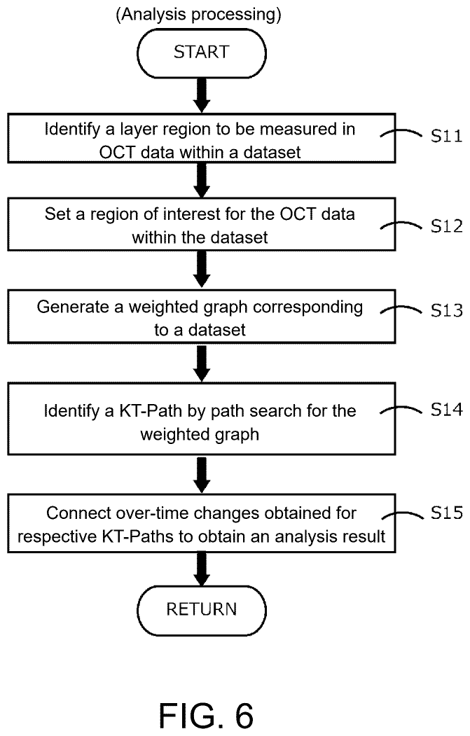

Next, the analysis processing in the example is described with reference to FIG. 6 to FIG. 11. FIG. 6 is a flowchart showing the flow of the analysis processing, and the description is provided according to this flowchart.

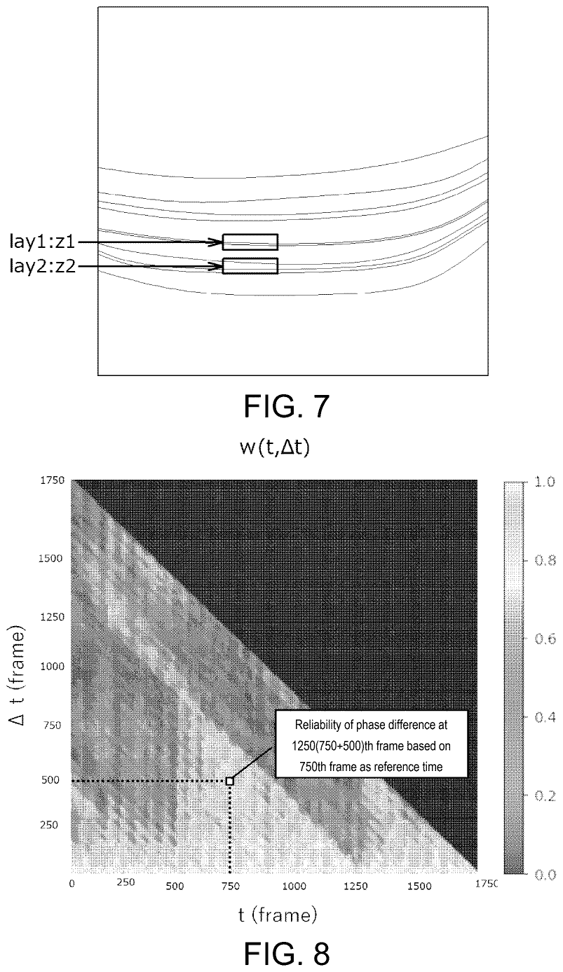

First, the arithmetic control unit 50 identifies a layer region to be measured in each OCT data within the dataset (S11). Hereinafter, one of the outermost layers (or layer boundaries) among the measurement targets is described as lay1 (z₁), and the other is described as lay2 (z₂). Which of the layers forming the retina is selected as lay1 and lay2 can be changed as appropriate for each examination according to the purpose. In the present example, as shown in FIG. 7, a case where the line (ellipsoid zone (EZ)) of the inner segment of photoreceptor cells is lay1 and the retinal pigment epithelium (retinal pigment epithelium (RPE)) is lay2 is described as an example. The arithmetic control unit 50 sets a window of an appropriate size as the region of interest 130 for each of lay1 and lay2 (S12).

In identifying the layer region, retinal layer segmentation for each OCT data may be executed by the arithmetic control unit 50. For example, at least one of the layers forming the retina is identified (detected) by image processing on an intensity OCT image. It is desirable that at least two layers, lay1 and lay2, are identified by retinal segmentation. For retinal layer segmentation, for example, conventional image processing such as edge detection may be utilized, or a mathematical model pre-trained by a machine learning algorithm may be utilized. For complex OCT images, for example, results of retinal segmentation on an intensity OCT image based on the same OCT data may be applied.

### <Knox-Thompson Method>

Next, the arithmetic control unit 50 analyzes phase information in the OCT data using an analysis method referred to as the Knox-Thompson method (KT method).

A complex OCT image at a certain time t is denoted as I(x,z,t). Each pixel of the complex OCT image is a complex number. Among I(x,z,t), attention is focused on two layers, lay1 and lay2. The time-dependent phase difference between the two layers of lay1 and lay2 is denoted as Δφ_{lay1/lay2}(t,Δt). Δφ_{lay1/lay2}(t,Δt) indicates the time-dependent phase difference between the two layers at a time t+Δt when the time t is the reference time.

Here, Δφ_{lay1/lay2}(t,Δt) is calculated based on the complex OCT image according to Equation (1) as follows. U indicates a cross spectrum, and M indicates pixels or the total number of pixels within the window.

$${Δφ}_{l a y 1 / l a y 2} ( t , Δ t ) = arg ( {U}_{l a y 1 / l a y 2}^{M} ( t , Δ t ) ) \qquad ( 1 )$$

Here:

$${U}_{lay 1 / lay 2}^{M} ( t , Δ t ) = \frac{1}{M} {\sum }_{x ∈ M} {U}_{lay 1 / lay 2} ( x , t , Δ t ) \qquad ( 2 )$$

$${U}_{lay 1 / lay 2} ( x , t , Δ t ) = {U}_{lay 1} ( x , {z}_{1} , t , Δ t ) \cdot {{U}_{lay 2} ( x , {z}_{2} , t , Δ t )}^{*} \qquad ( 3 )$$

$${U}_{lay} ( t , Δ t ) = I ( x , z , t ) \cdot {I ( x , z , t + Δ t )}^{*} \qquad ( 4 )$$

The change in thickness ΔL(t,Δt) between the two layers of lay1 and lay2 can be easily obtained from Δφ_{lay1/lay2}(t,Δt) according to Equation (5) as follows.

$$Δ L ( t , Δ t ) = Δ {φ}_{lay 1 / lay 2} ( t , Δ t ) \cdot \frac{λ}{4 π n} \qquad ( 5 )$$

However, λ is the center wavelength of the measurement light, and n is the refractive index. In this embodiment, λ=1060 nm and n=1.35 are used.

For example, when calculating Δφ_{lay1/lay2}(t,Δt) or ΔL(t,Δt), if the eye under examination moves during the period from the time t to the time t+Δt, noise may occur due to the movement of the eye under examination caused by the imaging system.

Comparatively, in the KT method, noise reduction is achieved by updating the reference time t. In the KT method, the concept called Knox-Thompson path (KT-Path) is introduced, and the dataset is divided into several sets (subsets) with different reference times t. KT-Path is a unit of a set to which the same reference time is applied, and several reference times and the same number of KT-Paths are set for one dataset. In other words, the dataset is divided into subsets for respective KT-Paths. In the KT method, by connecting the analysis results obtained for the respective KT-Paths, more reliable values can be obtained as analysis results from the analysis start time to each time.

Here, the arithmetic control unit 50 constructs a weighted graph corresponding to the dataset (S13). To construct the weighted graph, a reliability w(t,Δt) is introduced. The reliability w(t,Δt) is the phase correlation of each pixel in the two complex OCT images at the time t and the time t+Δt. w(t,Δt) can be obtained based on Equation (6) as follows.

$$w ( t , Δ t ) = \frac{\vert {\sum }_{x , z ∈ M} {U}_{l a y 1 / l a y 2} ( x , t , Δ t ) \vert}{{\sum }_{x , z ∈ M} \vert {U}_{l a y 1 / l a y 2} ( x , t , Δ t ) \vert} \qquad ( 6 )$$

The value of the reliability w(t,Δt) is 0 in the case of a completely random phase shift, and 1 in the case of a completely coherent phase shift.

The arithmetic control unit 50 obtains w(t,Δt) for each combination of the time t and the time t+Δt. That is, the time evolution of w(t,Δt) is obtained. As an example, in FIG. 8, the time evolution of w(t,Δt) is visualized. In FIG. 8, the horizontal axis indicates the time t, and the vertical axis indicates Δt. However, for convenience, in FIG. 8, the time t and the time Δt are used with the number of OCT frames as unit. For each element specified by (t,Δt), the reliability w(t,Δt) is given based on the calculation. On the graph of FIG. 8, each element is color-coded according to the reliability w(t,Δt).

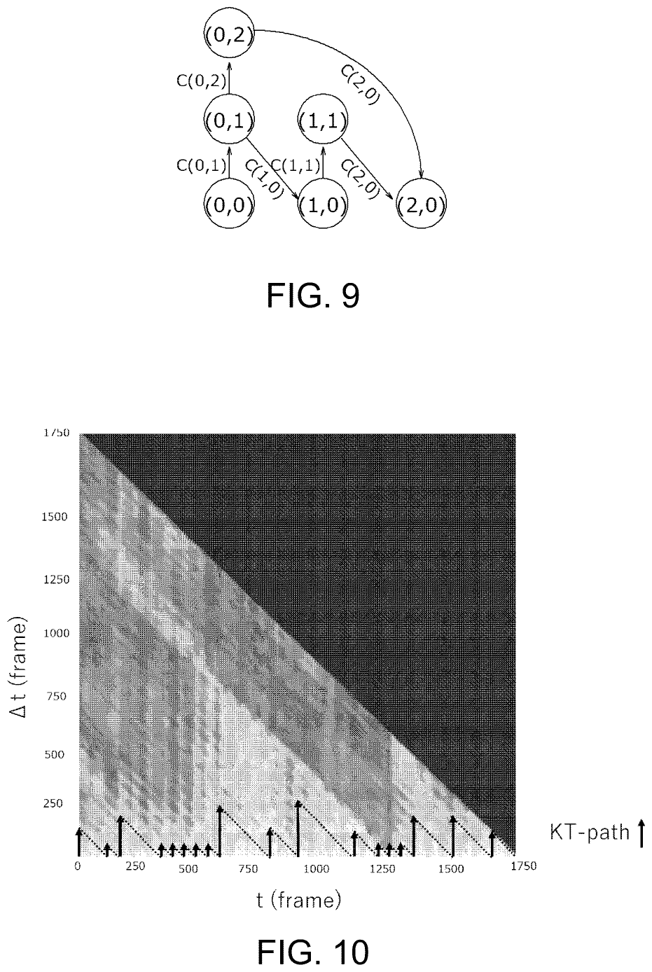

When the time evolution of w(t,Δt) is simply expressed in the range of t,Δt=0,1,2, a graph as shown in FIG. 9 is constructed. In the embodiment, the arithmetic control unit 50 constructs a weighted graph in which the time evolution of w(t,Δt) is directly reflected in a directed graph. The constructed weighted graph is shown in FIG. 9.

Here, the cost C(i,j) of the edge of the graph is defined as the reciprocal of w(t,Δt) (see Equation (7)).

$$C ( i , j ) = \frac{1}{w ( t , Δ t )} \qquad ( 7 )$$

In addition, each node shown in FIG. 9 corresponds to two pieces of image data (frames) as follows. The frame number is a serial number of each frame included in the dataset, with the initial frame in the dataset being number 0, and increasing by one according to the obtaining order.
(0,0): Frame number 0 and 0 (same)
(0,1): Frame number 0 and 1
(0,2): Frame number 0 and 2
(1,0): Frame number 1 and 1 (same)
(1,1): Frame number 1 and 2
(2,0): Frame number 2 and 2 (same)

In the case of constructing the weighted graph, the arithmetic control unit 50 may perform preprocessing so that the search for trivial shortest paths is omitted. For example, the preprocessing may exclude path elements close to Δt=0, or limit the number of nodes to pass through.

The arithmetic control unit 50 identifies the KT-Path by path search on the constructed weighted graph (S14). In the embodiment, the shortest path in the weighted graph (the path with the minimum sum or product of costs) is searched by using Dijkstra's algorithm, which is one of the shortest path search methods. However, the path search algorithm is not necessarily limited to this, and various algorithms can be used. For example, any of various algorithms may be appropriately used, such as algorithms for solving the shortest path problem other than Dijkstra's algorithm (for example, Bellman-Ford algorithm, Warshall-Floyd algorithm, etc.), breadth-first search (best-first search, uniform cost search, A*), depth-first search, iterative deepening depth-first search, depth-limited search, bidirectional search, branch and bound method, beam search, and the like.

In the shortest path of the weighted graph, each portion from the node j=0 corresponding to the OCT data at the reference time, proceeding in the vertical direction until turning back, corresponds to one KT-Path respectively. That is, the time when the shortest path turns back is set as the reference time t of the next KT-Path, and the KT-Path is identified for each reference time t. As an example, FIG. 10 shows the KT-Path superimposed on the time evolution of w(t,Δt).

Next, the arithmetic control unit 50 obtains Δφ_{lay1/lay2}(t,Δt) for each KT-Path. Also, the arithmetic control unit 50 obtains the change in phase difference from the analysis start time to each time by connecting Δφ_{lay1/lay2}(t,Δt) obtained for each KT-Path at the reference time (S15).

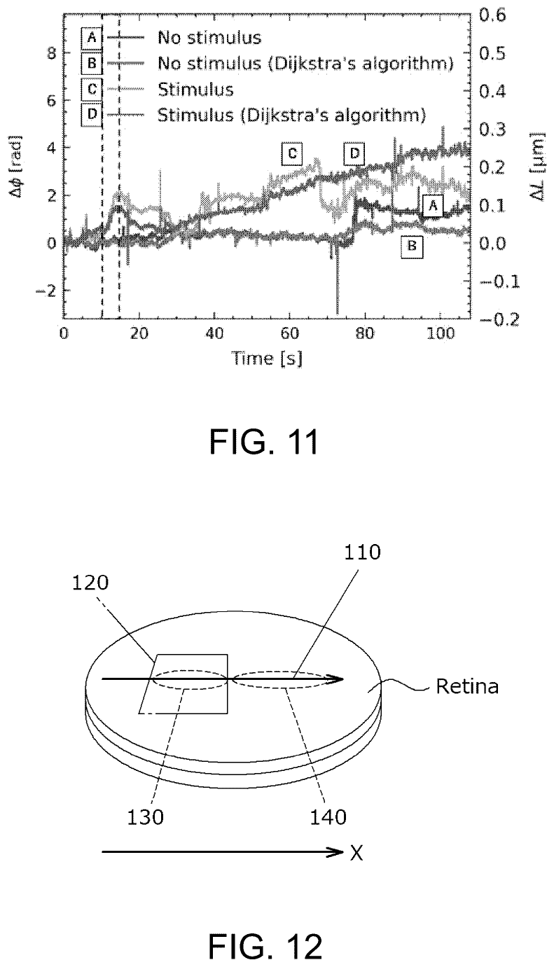

FIG. 11 shows the analysis result by the analysis method of the first embodiment. FIG. 11 is a graph showing the change amount in phase difference and layer thickness at each time from the start to the end of dataset obtaining.

FIG. 11 illustrates four series, i.e., series A to D, with different stimulation conditions and analysis conditions from each other. The stimulation conditions and analysis conditions of series A to D are as follows. Series A and C are comparative examples, and are results of analyses performed with KT-Paths that are set such that datasets are demarcated at regular time intervals, while series B and D are results of analyses performed by using the analysis method of the embodiment. Series A and series B, and series C and series D are respectively based on the same dataset, but differ in analysis method.
Series A: No light stimulation; uniform KT-Path
Series B: No light stimulation; KT-Path based on Dijkstra's algorithm
Series C: With light stimulation; uniform KT-Path
Series D: With light stimulation; KT-Path based on Dijkstra's algorithm

As shown in FIG. 11, in series A and C, the values change discontinuously at some points, whereas in series B and D, it can be seen that the values transition continuously as a whole. Furthermore, in series B where no light stimulation is performed, the change is substantially constant at 0, and in series D where light stimulation is performed, the state of functional activity of the retina is appropriately captured, in which the layer thickness changes rapidly during the period when light stimulation is performed, and thereafter the layer thickness changes gradually. In this manner, highly reliable analysis results can be obtained by the analysis method of the embodiment.

### Second Embodiment

Next, with reference to FIG. 12 to FIG. 16, the second embodiment will be described focusing on differences from the first embodiment. In the following description, the description of the first embodiment is incorporated for matters not mentioned, such as device configuration.

In the second embodiment, similar to the first embodiment, the region of interest 130 and a reference region 140 are set for each of multiple OCT data continuously obtained before, during, and after stimulation. In the retina of the eye under examination, the KT-Path in the dataset is determined based on image data of the reference region 140, which is different from the region of interest, rather than the region of interest where the measurement target is present in each OCT data. Based on the determined KT-Path, over-time change (for example, phase change and layer thickness change) in the region of interest are calculated. Preferably, the reference region 140 is set to tissue where no ORG signal based on light stimulation occurs. As an example, in the second embodiment, as shown in FIG. 12, the reference region 140 is set outside the stimulation range 120 on the retina.

### <Analysis Processing in Second Embodiment>

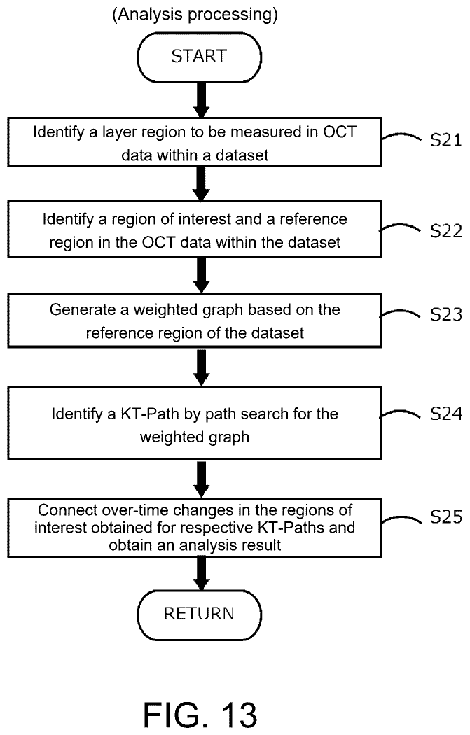

Next, with reference to FIG. 13 to FIG. 15, the analysis processing in the second embodiment will be described.

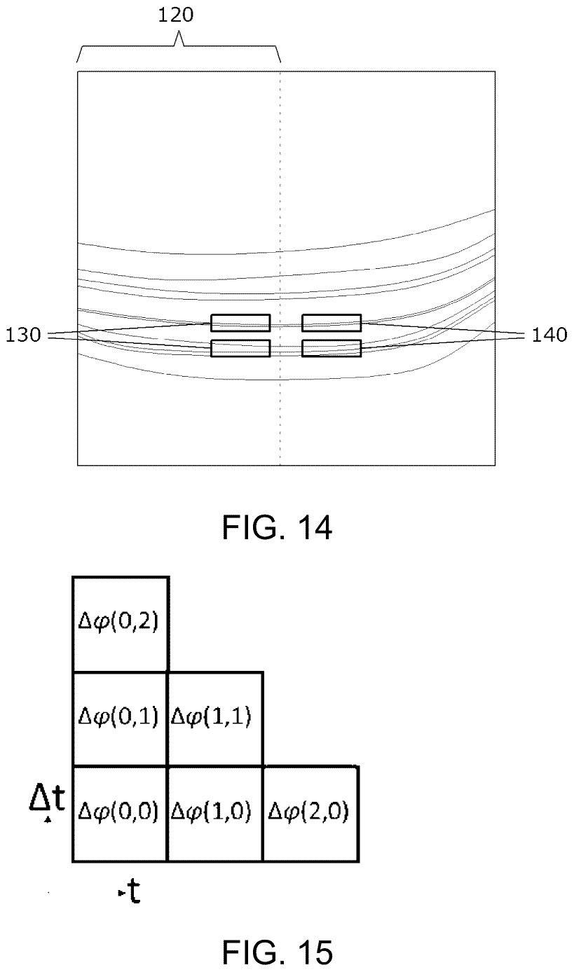

Description will be provided along the flowchart of FIG. 13. First, the region of interest 130 and the reference region 140 are identified in each OCT data within the dataset by the arithmetic control unit 50 (S21). As shown in FIG. 14, the arithmetic control unit 50 sets a window in an appropriate size for each of lay1 and lay2 as the region of interest 130. Similarly, a window in an appropriate size is set for each of lay1 and lay2 as the reference region 140.

Thereafter, the arithmetic control unit 50 constructs a weighted graph based on the image data in the reference region (S22).

First, the arithmetic control unit 50 obtains the phase difference Δφ_{lay1/lay2}(t,Δt) given by Equation (1) between the two windows set as the reference region, and further obtains the time evolution of the phase difference.

In the second embodiment, as shown in FIG. 14, a weighted graph is constructed from the time evolution of the phase difference. The phase difference is used as cost. A path that minimizes the cumulative sum of the absolute values of the phase difference obtained by the following equation is searched by a path search algorithm. Similar to the first embodiment, Dijkstra's method can be used as the path search algorithm.

$${D}_{i , j} = \{ \begin{matrix}\vert Δ φ ( i , j + 1 ) - Δ φ ( i , j ) \vert … where the path does not turn back \\ \vert Δ φ ( i + 1 , 0 ) - Δ φ ( i , j ) \vert … where the path turns back\end{matrix}$$

Here, t,Δt=0, 1, 2, . . . , etc.

By searching the weighted graph as described above by using a path search algorithm, a path with less system phase noise caused by eye movement or the like is appropriately selected. Based on the path, multiple KT-Paths in the dataset are identified. The arithmetic control unit 50 calculates the ORG data in the region of interest based on Equation (1) by using the identified KT-Paths. Accordingly, it is possible to obtain ORG data of the region of interest with high reliability.

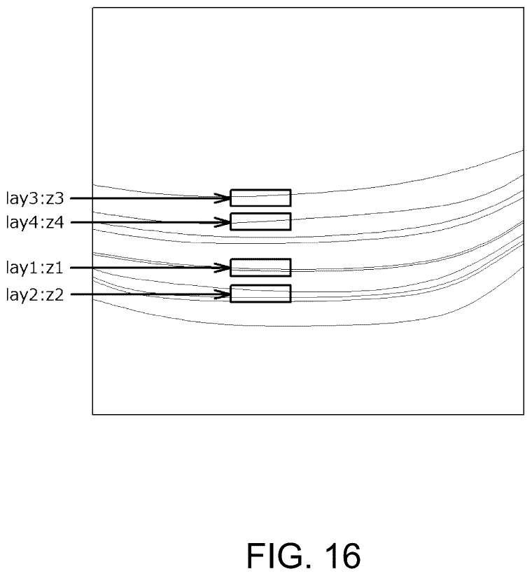

In the second embodiment, as shown in FIG. 12 and FIG. 14, the reference region 140 is set outside the stimulation range 120 on the retina. However, the disclosure is not necessarily limited thereto, and the reference region 140 may be set for the tissue in which no ORG signal based on light stimulation occurs, even within the stimulation range on the retina. As an example, as shown in FIG. 16, with respect to lay1 and lay2 where the region of interest is set, the reference region may be set at lay3: (z₃) and lay4 (z₄) on the shallower side.

### Third Embodiment

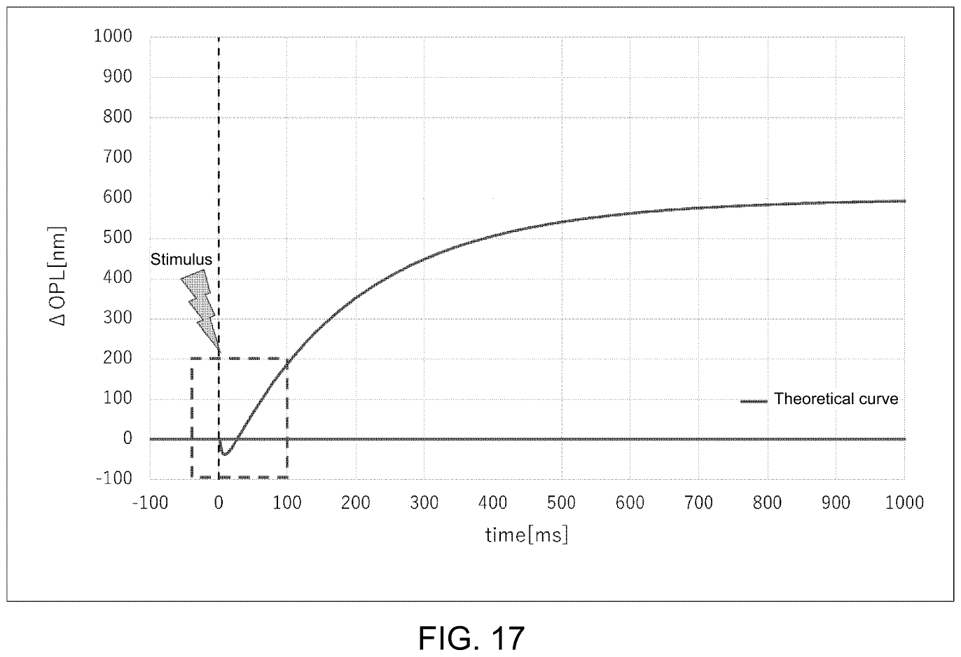

Next, with reference to FIG. 17 to FIG. 20, the third embodiment will be described focusing on differences from the first embodiment. In the following description, the description of the first embodiment is incorporated for matters not mentioned, such as device configuration.

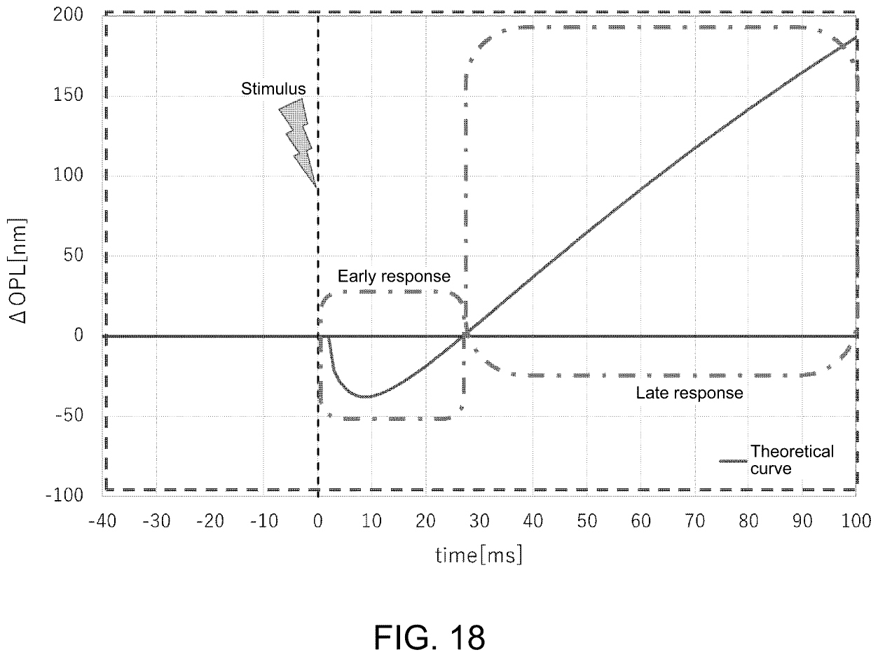

First, FIG. 17 and FIG. 18 show a model of the over-time change in the morphology of the photoreceptor outer segment in response to light stimulation. The over-time change in morphology is shown as the over-time change in optical path length (ΔOPL [nm]). FIG. 18 shows an enlarged view of the portion enclosed by the dashed line in FIG. 17. In response to light stimulation, the outer segment of the photoreceptor exhibits two types of responses with different timescales. As shown in FIG. 18, the outer segment contracts on a short timescale immediately after the stimulus. Thereafter, as shown in FIG. 17, the outer segment expands on a long timescale. Of the two types of responses shown in FIG. 17 and FIG. 18 respectively, the response with a short timescale is referred to as “early response,” and the response with a long timescale is called “late response.” The early response is said to result from “the disc membrane becoming hyperpolarized and the outer segment contracting due to electrical repulsion.” The late response is said to result from “a combination of a component from osmotic swelling caused by the generation of phosphate ions in cone photoreceptors and a component from the volume expansion of cone opsin and the volume expansion of the lipid membrane caused by pigment dissociation.”

In the first embodiment, OCT data (B-scan) is repeatedly captured at a constant obtaining rate throughout the examination period consisting of before light stimulation (12 seconds), during light stimulation (6 seconds), and after light stimulation (90 seconds). As a result, in the dataset analyzed by the arithmetic control unit 50, the interval between the imaging times of each OCT data was constant at 60 milliseconds per image. With such an interval, the late response is detected favorably as ORG, but the early response cannot be detected with high accuracy. That is, a sufficient number of OCT data is not captured for the timescale of the early response. On the other hand, if the interval between the imaging times of each OCT data is uniformly shortened throughout the entire examination period so that a sufficient number of OCT data is captured for the timescale of the early response, the number of OCT data becomes excessive for the late response. The data volume per examination becomes enormous, and the time required for analysis processing becomes prolonged.

Comparatively, in the third embodiment, the examination period is divided into several intervals including an interval corresponding to the early response and an interval corresponding to the late response, and OCT data is captured at a different obtaining rate for each interval. As a result, a dataset is obtained in which the interval between the imaging times of respective OCT data is adjusted according to the elapsed time within the examination period. Furthermore, in the third embodiment, each time OCT data is captured, a timestamp indicating the imaging time is obtained. The timestamp is an example of imaging time information. The arithmetic control unit 50 analyzes the OCT data included in the dataset by using each OCT data and the corresponding timestamp, thereby enabling the ORG signal to be appropriately obtained in each of the interval corresponding to the early response and the interval corresponding to the late response. The following provides a specific description.

In the third embodiment, the examination period is divided into two intervals: a first interval and a second interval. The first interval is an interval corresponding to the start of examination (before light stimulation) until the end of the early response. The first interval continues from the start of examination to 30 milliseconds immediately after the start of light stimulation. The second interval is an interval corresponding to the late response. The second interval is 89.97 seconds from 30 milliseconds after the start of light stimulation to 90 seconds after the start.

First, the obtaining position (scan position) of the OCT data in the third embodiment is described. Similar to the first embodiment, in the third embodiment, OCT data (B-scan) at the same scanline 110 is repeatedly obtained during the examination period (see FIG. 5). That is, multiple OCT data (B-scan) at the same scanline 110 are obtained while changing the scanning speed of the measurement light between the first interval and the second interval.

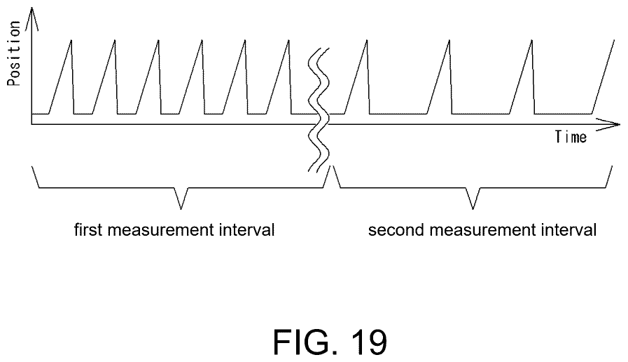

FIG. 19 shows the operation waveform in the scanning unit 15 at this time. However, it is assumed that the measurement light is scanned only in X-direction at each scanline, the scanning unit 15 is a galvano scanner, and the deflection angle of the galvano scanner is proportional to the magnitude of the drive signal.

As shown in FIG. 19, a wave that increases proportionally with time and drops sharply is repeatedly input as a waveform for one cycle. The waveform for one cycle corresponds to one B-scan. In the third embodiment, the drive signal in the first interval has a waveform with a shorter cycle repeatedly input than the drive signal input in the second interval. That is, in the first interval, OCT data is obtained at an interval of 1.5 milliseconds. Furthermore, in the second interval, OCT data is obtained at an interval of 60 milliseconds. Furthermore, in FIG. 19, the difference in cycle between the first interval and the second interval is represented as a difference in the waiting time until the next scan. Since the drive amount and the drive speed of the galvano scanner during scanning in the second interval are the same as those in the first interval, imaging in the second interval is also less susceptible to the influence of fixational eye movements and the like.

After a series of imaging, analysis processing is executed on multiple OCT data included in the dataset, and ORG data is obtained. In the third embodiment, the interval of imaging time of OCT data differs for each interval. Therefore, the arithmetic control unit 50 may perform the analysis processing for each interval. For example, the KT method shown in the first embodiment may be performed for each interval to obtain ORG data for each interval. This makes it easier to set an appropriate KT-path in each interval, so ORG data can be obtained with higher accuracy. In this case, a timestamp may be used for associating the optical path length value with the time axis in the ORG data. Furthermore, ORG data for the entire examination period may be obtained by connecting the ORG data obtained for each interval.

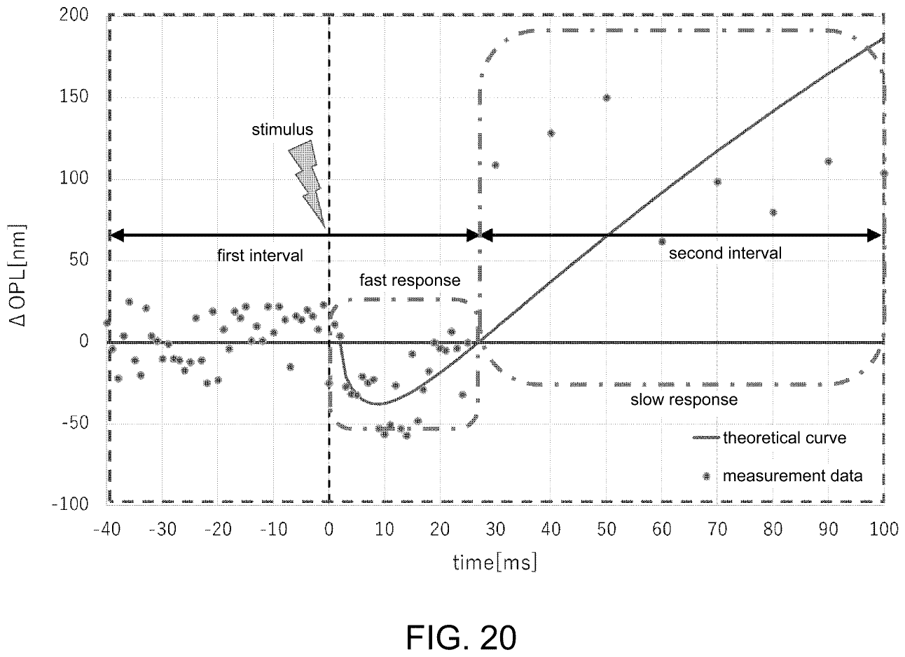

FIG. 20 shows examination results superimposed on the graph showing the time variation model of the morphology of the photoreceptor outer segment in response to light stimulation shown in FIG. 18. In this embodiment, in the first interval, OCT data is obtained at an interval of 1.5 milliseconds. The first interval is immediately after stimulation, and a fast response with a short timescale occurs, so imaging at a relatively short time interval makes it easier to appropriately detect tissue changes as ORG data. Furthermore, fast responses not only have a short timescale, but also have smaller tissue changes than slow responses, and the interval between imaging times of OCT data is short, noise due to eye movement and device fluctuation is suppressed, so even small changes are easily detected as ORG data with high accuracy.

Furthermore, in this embodiment, even immediately before stimulation, OCT data is obtained at the same 1.5 millisecond intervals as when the fast response is progressing, so ORG data with less noise is easily obtained for initial changes in the fast response.

In the second interval, OCT data is obtained at an interval of 60 milliseconds. Since a slow response with a long timescale occurs, imaging is performed at a relatively long time interval. Accordingly, it is possible for the tissue changes in the slow response to be appropriately detected as ORG data. Furthermore, since slow responses have a long timescale, by lengthening the interval between imaging times of OCT data, the data volume per examination and the time required for analysis processing are suppressed.

As described above, in the third embodiment, since the interval of imaging time of OCT data differs for each interval, multiple responses with different timescales (here, fast response and slow response) can be examined at once. In OCT-ORG, dark adaptation is required before examination, but in the third embodiment, the preparations for examination, such as dark adaptation and alignment for multiple responses with different timescales, can be completed in one session, so the time required for examination can be significantly reduced. As a result, the burden on the examiner and the subject can be reduced.

### Fourth Embodiment

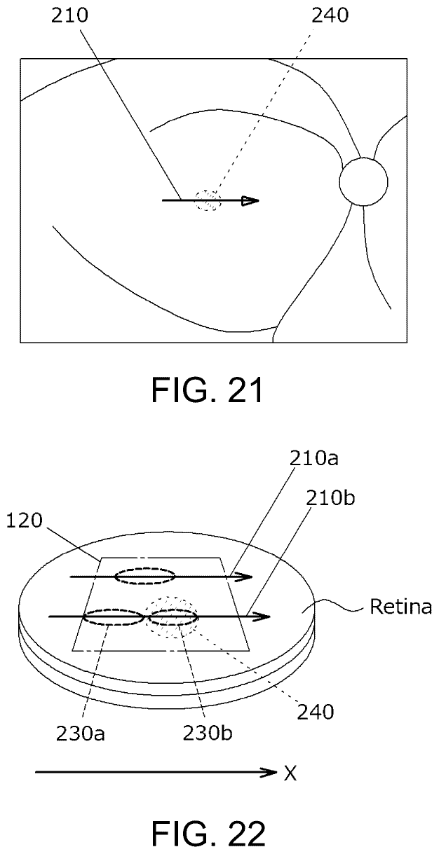

Next, with reference to FIG. 21 to FIG. 24, the fourth embodiment will be described focusing on differences from the first embodiment. In the following description, for matters not mentioned such as device configuration, the description of the first embodiment is incorporated.

In the first embodiment, the density of A-scan points in the transverse direction on the fundus is not particularly mentioned. Comparatively, in the fourth embodiment, the density of A-scan points may differ depending on the position in the transverse direction on the fundus. First, with reference to FIG. 21, the obtaining position (scan position) of OCT data in the fourth embodiment will be described. In the fourth embodiment, the obtaining position of OCT data is set via a fundus frontal image. The obtaining position is indicated by the position of a scanline 210 superimposed on the fundus frontal image displayed on the display device. The position of the scanline 210 can be changed based on an operation via the user interface 90, and the obtaining position of OCT data is also changed according to the position of the scanline 210.

In the fourth embodiment, when setting the obtaining position of OCT data, the arithmetic control unit 50 also sets the density of A-scan points according to the obtaining position. More specifically, the density of A-scan points at each position is set according to the positional relationship between the obtaining position of OCT data and the position of the feature region. For example, A-scan points are set at different densities between the inside and outside of the feature region in the fundus. In the case where the obtaining position of OCT data and the position of the feature region partially overlap, locations where A-scans are dense (high density) and sparse (low density) occur within one B-scan. As described later, inside the feature region, A-scan points are set more densely (high density) than the outside.

The feature region may be a region where the morphology of tissue differs from the surroundings. The optic nerve head, fovea, blood vessels, lesions, abnormal sites, and the vicinity of each are given as examples of the feature region. At the time of setting the obtaining position of OCT data, it is desirable that the position of the feature region is obtained in advance. As shown in FIG. 21, at the position of the feature region, a graphic 240 indicating the feature region may be superimposed on the fundus frontal image.

The feature region may be detected from an image. At least the position information of the feature region is obtained as a detection result. The image type used for position detection of the feature region and the content of processing (image processing or analysis processing) used for detection can be appropriately selected according to the type of the feature region. The image used for detection of the feature region may be a fundus frontal image obtained via the frontal imaging optical system 40a, or may be OCT data of a wide range. Also, the position of the feature region may be input via the user interface 90. A fundus image including the feature region may be displayed upon input. The position of the feature region is input by specifying the position on the fundus image via the user interface 90.

In the fourth embodiment, the arithmetic control unit 50 performs sampling of A-scans at constant time intervals. In order to set the density of A-scan points according to the obtaining position, the arithmetic control unit 50 changes the scanning speed of measurement light on the fundus according to the position on the fundus.

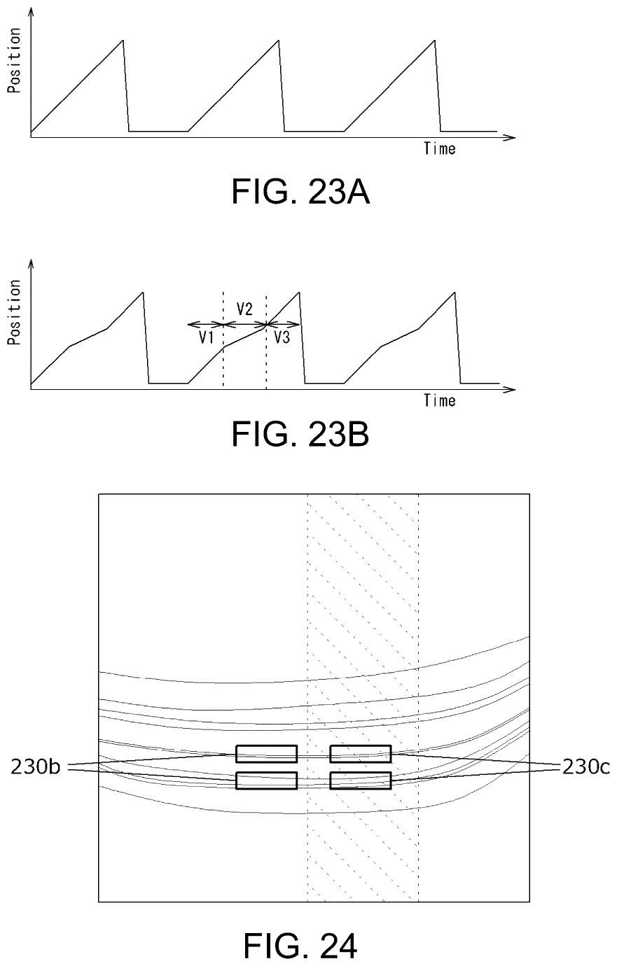

Here, with reference to FIG. 22, FIG. 23A, and FIG. 23B, control of the scanning unit 15 during examination is described more specifically. The control of the scanning unit 15 for each of a first scanline 210a that does not overlap with the feature region 240 and a second scanline 210b that partially overlaps with the feature region 240 is described and compared.

Here, for convenience, the description is provided based on premises a) to c) as follows. However, the disclosure is not necessarily limited thereto.
a) In each scanline, the measurement light is scanned only in X-direction.
b) The scan length of each scanline is equal.
c) The scanning unit 15 is a galvano scanner. In this case, the deflection angle of the galvano scanner is proportional to the magnitude of the drive signal.

FIG. 23A and FIG. 23B show operation waveforms for respective scanlines 230a and 230b. In the case where the obtaining position of OCT data is the first scanline 230a, a sawtooth wave shown in FIG. 23A is input to the scanning unit 15 as a drive signal. Specifically, a wave that increases in proportion to time and drops sharply is repeatedly input at constant intervals as a waveform for one cycle. The waveform for one cycle corresponds to one B-scan. As a result of such drive signal being input to the scanning unit 15, the measurement light is repeatedly scanned at a constant speed for the first scanline 210a.

In the case where the obtaining position of OCT data is the second scanline 210b, the drive signal shown in FIG. 23B is input to the scanning unit 15. The waveform of the input sawtooth wave differs from the waveform shown in FIG. 23A for comparison. In the waveform shown in FIG. 23B, the slope is changed in the middle of the interval where the drive signal monotonically increases. As a result, the scanning speed of the measurement light is changed while scanning the second scanline 210b. In FIG. 23B, the interval where the drive signal monotonically increases is shown as three intervals V1, V2, and V3. The interval V2, which has a relatively small slope compared to the intervals V1 and V3, corresponds to the outside of the feature region. The intervals V1 and V3, which have a relatively small slope, correspond to the inside of the feature region. Accordingly, in the fourth embodiment, the measurement light is scanned at a slower speed inside the feature region than the outside, so the A-scan points are set densely (at high density). The timing at which the slope of the drive signal switches is set in advance based on the positional relationship between the obtaining position of OCT data and the feature region.

Here, in the fourth embodiment, the time required per B-scan when scanning the second scanline 210b is longer than the case of scanning the first scanline 210a. Therefore, by adjusting the time from when each B-scan ends until the next B-scan starts, the interval of imaging time of OCT data is kept constant regardless of the obtaining position of OCT data.

Based on the control of the scanning unit 15, a dataset formed by multiple OCT data is obtained at each scanline.

Next, the analysis processing in the fourth embodiment is described. Here, the analysis processing for the dataset obtained at the second scanline 210b is described. For the analysis processing for the dataset obtained at the first scanline 210a, the descriptions in other embodiments can be referenced.

In the analysis processing of the fourth embodiment as well, first, one or more regions of interest are set in the OCT data. Multiple regions of interest may be set at positions different from each other with respect to the transverse direction. Here, as an example, a total of two regions of interest 230a and 230b are set, one each in the feature region and its outer region.

In the fourth embodiment, the positions of the regions of interest 230a and 230b are input via the user interface. During input, a fundus image is displayed, and the regions of interest 230a and 230b are set by specifying the positions of the regions of interest 230a and 230b on the fundus image via the user interface. For example, as shown in FIG. 24, any of the OCT data (B-scan) included in the dataset may be displayed as the fundus image. As described in the first embodiment, the regions of interest 230a and 230b are set by specifying the position of the window indicating the region of interest on the OCT data. In this case, the positions in the transverse direction and the depth direction are specified as the positions of the respective regions of interest 230a and 230b. However, the disclosure is not necessarily limited thereto. As the fundus image, a frontal image of the fundus may be displayed, and the regions of interest 230a and 230b may be set by specifying the positions of the regions of interest 230a and 230b on the frontal image. In this case, the position in the transverse direction is specified as the position of each of the regions of interest 230a and 230b. Additionally, both the B-scan and the frontal image may be displayed.

In the case of setting the regions of interest 230a and 230b via the fundus image, it is desirable that the feature region 240 is highlighted in the fundus image. In FIG. 24, the range in the transverse direction where the feature region 240 is present in the OCT data is shaded, thereby highlighting the feature region 240. However, the manner of highlighting is not necessarily limited thereto and can be changed as appropriate. By highlighting the feature region 240 on the fundus image, it becomes easy to set the region of interest 230b in the feature region 240, or conversely, to set the region of interest 230a at a position avoiding the feature region 240.

In the fourth embodiment, the same analysis processing as in the first embodiment is executed for each of the two regions of interest 230a and 230b, and ORG data is obtained for each of the regions of interest 230a and 230b. For the region of interest 230a set outside the feature region 240, the ORG data is obtained with high accuracy. Additionally, in the region of interest 230b set in the feature region 240 as well, in the fourth embodiment, by setting the A-scan points more densely (at high density) than outside the feature region 240, degradation in the accuracy of the ORG data is suppressed.

### Modified Examples

Although the embodiments of the technology disclosed herein have been described in detail above, these are merely examples and do not limit the scope of the claims. The technology described in the claims includes various modifications and changes of the embodiments exemplified above.

### <Other Graph Construction Examples>

For example, in the first embodiment and the second embodiment, the graph used for path search is merely an example and the disclosure is not necessarily limited thereto.

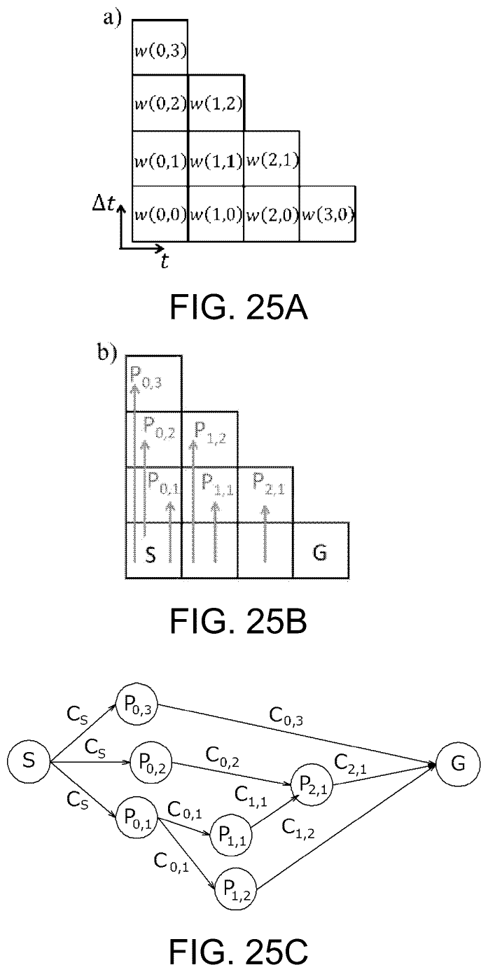

For example, as the graph of the first embodiment, the graphs shown in FIG. 25A to FIG. 25C can be used. For example, FIG. 25A uses the time evolution of the reliability w(t,Δt) directly as a graph. Additionally, FIG. 25B is a graph showing the elements of KT-Path as P_{m,n}. FIG. 25C is a weighted directed graph formed by all KT-Paths. In FIG. 25C, P_{m,n} serves as nodes, and the cost shown by Equation (8) in the following is assigned to the edges.

$$C ( i , j ) = \frac{1}{{\prod }_{n = 0}^{j} w ( i , n )} \qquad ( 8 )$$

### <Optimization Method Using Bit Array>

Additionally, for example, in the first and second embodiments described above, the KT-Path is determined by using the shortest path search method, but the disclosure is not necessarily limited thereto. The KT-Path may be determined by using an optimization method utilizing a bit array.

In this method, a bit array corresponding to the dataset is used. The bit array is represented by the number of image data included in the dataset and the corresponding number of bits. Here, the image data at the reference time is represented as “1”, and the others are represented as “0”. For example, an example of a bit array when the dataset is formed by 8 frames of image data is shown below. First, only frame number 0 indicates the bit array of the image data at the reference time.

$$r = ( 1 , 0 , 0 , 0 , 0 , 0 , 0 , 0 )$$

Additionally, only frame numbers 0 and 4 indicate the bit array of the image data at the reference time.

$$r = ( 1 , 0 , 0 , 0 , 1 , 0 , 0 , 0 )$$

The phase difference Δφ′(t) changes according to the bit array. The phase difference Δφ′(t) is a value for the entire dataset, and is a connection of the phase differences for the respective subsets. By setting some evaluation function that evaluates the phase difference Δφ′(t) and finding the bit array that minimizes the evaluation function, the image data at the reference time in the dataset is identified according to the bit array. As a result, the KT-Path is determined.

An example of the evaluation function is shown in Equation (9).

$$E = α {\sum }_{t = 0}^{N - 2} \vert Δ {φ}^{′} ( t + 1 ) - Δ {φ}^{′} ( t ) \vert + β {\sum }_{t = 0}^{N - 1} \vert {Δφ}^{′} ( t ) \vert \qquad ( 9 )$$

Here, N is the number of frames, and α and β are coefficients representing the weights of respective terms. In Equation (9), the first term indicates the difference in phase difference between image data. The first term is introduced to suppress large changes from occurring locally. The second term indicates the connected phase differences. It is introduced to suppress large changes from occurring globally.

Examples of the optimization methods for the bit array include brute force and genetic algorithm (GA). In the brute force method, calculations are performed for all array patterns, and the array with the minimum evaluation value is selected as the optimal bit array. However, the brute force method is not practical when the number of frames is large, because the computational complexity increases as a power of the number of frames.

The genetic algorithm is an algorithm that mimics the mechanism of biological evolution, and is a method for finding the optimal pattern by repeatedly performing operations such as crossover (combining arrays with good evaluation values) and mutation (randomly changing the array with a certain probability to avoid falling into local solutions). By repeating operations through the genetic algorithm, an optimal or near-optimal bit array can be obtained.

### <Regarding Application of Tracking Control>

In the first to fourth embodiments, the so-called tracking processing may be applied while capturing multiple OCT data during the examination period. Through the tracking processing, the scanning position of the measurement light follows the movement of the eye under examination while capturing multiple OCT data. In this case, when the movement of the eye under examination equal to or greater than a threshold is detected, the control to correct the scanning position between each B-scan is intervened. For detection of the movement of the eye under examination, for example, a fundus frontal image obtained through an SLO optical system may be used.

However, in the first interval corresponding to the fast response in the third embodiment, there is a concern that tracking processing may intervene and imaging of OCT data during this time may not be performed, resulting in an insufficient number of OCT data being obtained in the interval. Comparatively, in the first interval, the intervention of the tracking processing may be turned off, or the threshold of movement of the eye under examination that triggers the intervention of tracking processing may be set to a larger value than the threshold in the second interval. By doing so, even when tracking processing is applied to the third embodiment, OCT data can be properly obtained in each interval.

### Configurations Disclosed in Embodiments

In addition, the present disclosure describes the following ophthalmologic image processing programs A1 to A8, C1 to C4, E1 to E6, G1 to G3, ophthalmologic image processing devices B, D, and ophthalmologic examination methods F, H.

### <Ophthalmologic Image Processing Program A1>

An ophthalmologic image processing program is provided. When executed by a processor of an ophthalmologic image processing device, the ophthalmologic image processing program causes the ophthalmologic image processing device to execute: a dataset obtaining step of obtaining a dataset formed by multiple image data of an eye under examination, the image data being ordered in time series; and an analysis processing step of dividing the dataset into multiple subsets demarcated by several reference times, obtaining first change-over-time information indicating over-time change from the reference time of tissue of the eye under examination for each of the subsets, and obtaining second change-over-time information by performing a connection process on the first change-over-time information of each of the subsets. The analysis processing step determines each of the subsets based on an evaluation value of change between the respective image data in the dataset so that image data uncorrelated with the image data at the reference time is not included in each of the subsets.

### <Ophthalmologic Image Processing Program A2>

In the ophthalmologic image processing program A1, in the analysis processing step, a graph relating to the evaluation value between the respective image data in the dataset is constructed, and the dataset is divided based on a path search for the graph.

### <Ophthalmologic Image Processing Program A3>

In the ophthalmologic image processing program A2, an algorithm for the path search is an algorithm for solving a shortest path problem in the graph.

### <Ophthalmologic Image Processing Program A4>

In the ophthalmologic image processing program A1, in the analysis processing step, a bit array that corresponds to the dataset and represents the image data at the reference time and other image data with different values is used, and each time the bit array is changed, the bit array is evaluated by using an evaluation function relating to the evaluation value, thereby identifying an optimal bit array and dividing the dataset according to the identified bit array.

### <Ophthalmologic Image Processing Program A5>

In any one of the ophthalmologic image processing programs A1 to A4, the image data of the eye under examination in the dataset is OCT data of a fundus of the eye under examination.

### <Ophthalmologic Image Processing Program A6>

In the ophthalmologic image processing program A5, in the analysis processing step, the first change-over-time information and the second change-over-time information are obtained by obtaining a over-time change of a phase difference in the multiple OCT data ordered in time series in the dataset.

### <Ophthalmologic Image Processing Program A7>

In any one of the ophthalmologic image processing programs A1 to A6, the image data of the eye under examination in the dataset includes image data of a light-stimulated fundus, and in the analysis processing step, an ORG signal is obtained as the change-over-time information.

### <Ophthalmologic Image Processing Program A8>

In the ophthalmologic image processing program A7, the analysis processing step includes: a region setting step of constructing a graph relating to a correlation between the respective image data in the dataset, dividing the dataset based on a path search for the graph, setting a region of interest for a first tissue of the fundus that responds to a light stimulus in each of the image data, and setting a reference region for a second tissue of the fundus that has a smaller response to the light stimulus than the first tissue. In the analysis processing step, the graph is constructed based on a portion of the image data in the reference region at each time, the dataset is divided into the subsets based on the path search for the graph, and the first change-over-time information is obtained by processing the portion of the image data included in the region of interest at each time in each of the subsets.

### <Ophthalmologic Image Processing Device B>

An ophthalmologic image processing device that executes any one of the ophthalmologic image processing programs A1 to A8 is provided.

### <Ophthalmologic Image Processing Program C1>

An ophthalmologic image processing program is provided. When executed by a processor of an ophthalmologic image processing device, the ophthalmologic image processing program causes the ophthalmologic image processing device to execute: a dataset obtaining step of obtaining a dataset that are multiple image data ordered in time series and includes image data of a fundus of a light-stimulated eye under examination; a region setting step of setting a region of interest for a first tissue that responds to a light stimulus and setting a reference region for a second tissue that has a smaller response to the light stimulus than the first tissue, in fundus tissue including a retina of the eye under examination in each of the image data; and an analysis processing step of obtaining an ORG signal of the tissue of the eye under examination in the region of interest by performing analysis processing on the dataset. In the analysis processing step, the ORG signal in the region of interest is obtained in which a over-time change component commonly occurring in the region of interest and the reference region is reduced, based on a portion of the image data in the reference region at each time.

### <Ophthalmologic Image Processing Program C2>

In the ophthalmologic image processing program C1, the image data of the eye under examination in the dataset is OCT data of a fundus of the eye under examination.

### <Ophthalmologic Image Processing Program C3>

In the ophthalmologic image processing program C1 or C2, in the region setting step, the reference region is set with tissue located outside an irradiation range of stimulation light in the light stimulus as the second tissue.

### <Ophthalmologic Image Processing Program C4>

In the ophthalmologic image processing program C2, in the region setting step, the reference region is set for a layer region different from the region of interest.

<Ophthalmologic image processing device D>

An ophthalmologic image processing device that executes the ophthalmologic image processing program according to any one of the ophthalmologic image processing programs C1 to C4 is provided.

### <Ophthalmologic Image Processing Program E1>

An ophthalmologic image processing program is provided. When executed by a processor of an ophthalmologic examination system, the ophthalmologic image processing program is provided causes the ophthalmologic examination system to execute: a dataset obtaining step of obtaining a dataset formed by multiple image data ordered in time series as a result of repeatedly imaging a certain range in an eye under examination during an examination period through an imaging optical system, an interval of imaging time of each of the image data being adjusted according to elapsed time within the examination period; a time obtaining step of obtaining imaging time information indicating the imaging time of each of the image data included in the dataset; an analysis processing step of obtaining change-over-time information indicating a over-time change in a local region of the eye under examination during the examination period by analysis processing based on the dataset and the imaging time information; and a display control step of displaying the change-over-time information on a monitor.

### <Ophthalmologic Image Processing Program E2>

In the ophthalmologic image processing program E1, the examination period includes at least a first interval and a second interval having a different elapsed time from the first interval, and in the dataset obtaining step, the dataset is obtained in which the interval of the imaging time is adjusted to be different between multiple image data corresponding to the first interval and multiple image data corresponding to the second interval.

### <Ophthalmologic Image Processing Program E3>

In any one of the ophthalmologic image processing programs E1 to E2, an imaging control step is further executed, in which by controlling the imaging optical system, the predetermined region is continuously and repeatedly imaged through the imaging optical system while changing the interval of the imaging time at least according to the elapsed time in the examination period.

### <Ophthalmologic Image Processing Program E4>

In any one of the ophthalmologic image processing programs E1 to E3, the image data of the eye under examination in the dataset includes image data of a light-stimulated fundus, and in the analysis processing step, an ORG signal is obtained as the change-over-time information.

### <Ophthalmologic Image Processing Program E5>

In any one of the ophthalmologic image processing programs E1 to E4, the imaging optical system is an OCT optical system for obtaining OCT data of the eye under examination as the image data.

### <Ophthalmologic Image Processing Program E6>

An ophthalmologic image processing device that executes any one of the ophthalmologic image processing programs E1 to E5 is provided.

### <Ophthalmologic Examination Method F>

An ophthalmologic examination method implemented by a processor of an ophthalmologic examination system that analyzes over-time change of an eye under examination is provided.

The ophthalmologic examination system includes an irradiation optical system that irradiates the eye under examination with stimulation light, an imaging optical system that images the eye under examination, and a monitor. The method includes: irradiating the eye under examination with stimulation light via the irradiation optical system; repeatedly imaging a certain range of the eye under examination by controlling the imaging optical system during an examination period in which the stimulation light is irradiated over a portion or all of the period; obtaining a dataset formed by multiple image data ordered in time series, an interval of imaging time of each of the image data being adjusted according to elapsed time within the examination period; obtaining imaging time information indicating imaging time of each of the image data included in the dataset; obtaining change-over-time information indicating over-time change of a local region of the eye under examination during the examination period by analysis processing based on the dataset and the imaging time information timestamp; and displaying the change-over-time information on the monitor.

### <Ophthalmologic Image Processing Program G1>

An ophthalmologic image processing program implemented by a processor of an ophthalmologic examination system that analyzes over-time change of an eye under examination is provided. When the ophthalmologic image processing program is executed by the processor of the ophthalmologic examination system, the ophthalmologic examination system executes: a dataset obtaining step of obtaining, as a result of imaging, a dataset including multiple OCT data ordered in time series as a result of repeatedly imaging a certain range of the eye under examination via an OCT device during an examination period, a density of A-scan points in each of the OCT data differing according to a position on the fundus in a transverse direction; a region of interest setting step of setting a region of interest at a corresponding position among multiple OCT data included in the dataset; and an analysis processing step of obtaining change-over-time information indicating over-time change of tissue of the eye under examination in the region of interest by analysis processing that analyzes the dataset.

### <Ophthalmologic Image Processing Program G2>

In the ophthalmologic image processing program G1, in the region of interest setting step, the regions of interest are set for respective local regions having mutually different positions on the fundus in the transverse direction, and, in the analysis processing step, the change-over-time information for each of the local regions is obtained by analyzing the dataset.

### <Ophthalmologic Image Processing Program G3>

In the ophthalmologic image processing program G1, a second obtaining step of obtaining a position of a feature region in the fundus, and a density adjustment step of adjusting a density of A-scan points in the OCT data according to a positional relationship between the feature region in the eye under examination and the imaging range in the OCT data are further executed.

### <Ophthalmologic Examination Method H>

An ophthalmologic examination method implemented by a processor of an ophthalmologic examination system that analyzes over-time change of an eye under examination is provided. The ophthalmologic examination system includes an irradiation optical system that irradiates the eye under examination with stimulation light, and an OCT device that scans measurement light on a fundus of the eye under examination and images OCT data of the fundus based on a spectral interference signal between return light of the measurement light and reference light. The method includes: irradiating the fundus of the eye under examination with the stimulation light via the irradiation optical system; repeatedly imaging OCT data of a certain imaging range irradiated with the stimulation light via the OCT device; obtaining, as a result of the imaging, a dataset including multiple OCT data ordered in time series, a density of A-scan points in each of the OCT data differing according to a position on the fundus in a transverse direction; setting a region of interest at a corresponding position among the multiple OCT data included in the dataset; and obtaining change-over-time information indicating over-time change of tissue of the eye under examination in the region of interest by analysis processing that analyzes the dataset.

What is claimed is:

1. A non-transitory computer readable medium, storing an ophthalmologic image processing program, when executed by a processor of an ophthalmologic image processing device, the ophthalmologic image processing program causing the ophthalmologic image processing device to execute:
a dataset obtaining step of obtaining a dataset formed by a plurality of image data of an eye under examination ordered in time series; and
an analysis processing step of dividing the dataset into a plurality of subsets demarcated by one or more reference times, obtaining first change-over-time information indicating over-time change of tissue of the eye under examination from the reference time for the respective subsets, and obtaining second change-over-time information by performing a connection process on the first change-over-time information of the respective subsets,
wherein the analysis processing step determines each of the subsets based on an evaluation value of change between the respective image data in the dataset, such that the respective subsets do not comprise image data uncorrelated with the image data at the reference time.

2. The non-transitory computer readable medium according to claim 1, wherein:
in the analysis processing step, a graph relating to the evaluation value between the respective image data in the dataset is constructed, and the dataset is divided based on path search for the graph.

3. The non-transitory computer readable medium according to claim 2, wherein:
an algorithm for the path search is an algorithm for solving a shortest path problem in the graph.

4. The non-transitory computer readable medium according to claim 1, wherein
in the analysis processing step, a bit array that corresponds to the dataset and represents the image data at the reference time and other image data with different values is used, and each time the bit array is changed, the bit array is evaluated by using an evaluation function relating to the evaluation value, thereby identifying an optimal bit array and dividing the dataset according to the bit array that is identified.

5. The non-transitory computer readable medium according to claim 1, wherein
the image data of the eye under examination in the dataset is OCT data of a fundus of the eye under examination.

6. The non-transitory computer readable medium according to claim 5, wherein
in the analysis processing step, the first change-over-time information and the second change-over-time information are obtained by obtaining an over-time change of a phase difference in a plurality of the OCT data ordered in time series in the dataset.

7. The non-transitory computer readable medium according to claim 1, wherein:
the image data of the eye under examination in the dataset comprises image data of a light-stimulated fundus, and
in the analysis processing step, an ORG signal is obtained as the change-over-time information.

8. The non-transitory computer readable medium according to claim 7, wherein
in the analysis processing step, a graph relating to correlation between the respective image data in the dataset is constructed, and the dataset is divided based on path search for the graph,
a region setting step of, in each of the image data, setting a region of interest for a first tissue of the fundus that responds to a light stimulus, and setting a reference region for a second tissue of the fundus that has a response to the light stimulus smaller than the first tissue, and
in the analysis processing step, the graph is constructed based on a portion of the image data in the reference region at each time, the dataset is divided into a plurality of the subsets based on the path search for the graph, and the first change-over-time information is obtained by processing the portion of the image data comprised in the region of interest at each time in the respective subsets.

9. An ophthalmologic image processing device, executing the ophthalmologic image processing program according to claim 1.
